(19) United States
(12) Patent Application Publication
(10) Pub. No.: US 2026/0279893 A1
(43) Pub. Date: Sep. 17, 2026

(54) SECONDARY BATTERY AND ELECTRIC APPARATUS

(71) Applicant: Ningde Amperex Technology Limited, Ningde (CN)

(72) Inventors: Jun HE, Ningde (CN); Manman LIU, Ningde (CN)

(73) Assignee: Ningde Amperex Technology Limited, Ningde (CN)

(21) Appl. No.: 19/670,599

(22) Filed: May 7, 2026

Related U.S. Application Data
(63) Continuation of application No. PCT/CN2023/130387, filed on Nov. 8, 2023.

(51) Int. Cl. H01M 10/056; H01M 4/02; H01M 10/0525; H01M 10/0567; H01M 10/0568; H01M 10/0569; H01M 50/417; H01M 50/42; H01M 50/426; H01M 50/443; H01M 50/457; H01M 50/46; H01M 50/489

(52) U.S. Cl. CPC H01M 10/056; H01M 10/0567; H01M 10/0568; H01M 10/0569; H01M 50/417; H01M 50/42; H01M 50/426; H01M 50/443; H01M 50/457; H01M 50/461; H01M 50/489; H01M 2004/021; H01M 2004/027; H01M 10/0525; H01M 2300/002; H01M 2300/0037

(57) ABSTRACT

A secondary battery includes a positive electrode sheet, a negative electrode sheet, a separator, and an electrolyte, where the positive electrode sheet includes a positive electrode active material layer. The negative electrode sheet includes a negative electrode active material layer. A coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm². The separator includes a separator substrate, a first adhesive coating, and a second adhesive coating, where the first adhesive coating and the second adhesive coating are respectively provided on two sides of the separator substrate. The electrolyte includes chain carboxylate. Based on a mass of the electrolyte, a mass percentage of the chain carboxylate is 6% to 56%.

### CROSS REFERENCE TO THE RELATED APPLICATIONS

This application is a continuation application of International Application No. PCT/CN2023/130387, filed on Nov. 8, 2023, the contents of which are incorporated herein by reference in its entirety.

### TECHNICAL FIELD

This application relates to the field of electrochemical technologies, and in particular, to a secondary battery and an electric apparatus.

### BACKGROUND

Secondary batteries, such as lithium-ion batteries, have characteristics of high specific energy, high operating voltage, low self-discharge rate, small volume, and light weight, and are widely used in various fields such as electric energy storage, portable electronic devices, and electric vehicles. With the continuous iterative development of consumer lithium-ion batteries in recent years, the market's requirements for their charging speed are increasingly high, the proportion of fast-charging products gradually increases, the charging rate continuously increases, and the consumer demand has gradually increased from 1C to 3C, 5C, 6C, 7C, and 10C. At a rate of 10C, the full charge time of lithium-ion batteries is less than 15 min, bringing users extremely good experience and providing extremely great convenience for daily life.

However, in order to meet the requirements of fast charging and cycling, the high-temperature storage performance of lithium-ion batteries is affected, because under fast charging (with a charging rate greater than or equal to 5C) and high-temperature conditions (for example, the temperature greater than or equal to 40° C.), the side reactions in lithium-ion batteries increase. Therefore, how to guarantee the cycling performance of lithium-ion batteries under fast charging conditions and the storage performance under high-temperature conditions has become an urgent technical problem to be solved by those skilled in the art.

### SUMMARY

This application is intended to provide a secondary battery to guarantee the cycling performance and high-temperature storage performance of the secondary battery. In addition, an electric apparatus using the secondary battery is provided.

It should be noted that in the summary of this application, an example in which a lithium-ion battery is used as a secondary battery is used to illustrate this application. However, the secondary battery in this application is not limited to the lithium-ion battery, and can also be applied to a secondary battery such as a sodium-ion battery. The specific technical solutions are described below.

According to a first aspect of this application, a secondary battery is provided and includes a positive electrode sheet, a negative electrode sheet, a separator, and an electrolyte, where the positive electrode sheet includes a positive electrode active material layer; the negative electrode sheet includes a negative electrode active material layer; a coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm²; the separator includes a separator substrate, a first adhesive coating, and a second adhesive coating, where the first adhesive coating and the second adhesive coating are respectively provided on two sides of the separator substrate; the first adhesive coating includes a first polymer binder, and an average particle size of the first polymer binder is 0.3 μm to 3 μm; the second adhesive coating includes a second polymer binder, and an average particle size of the second polymer binder is 10 μm to 38 μm; the electrolyte includes an organic solvent, a lithium salt, and an additive; the organic solvent includes chain carboxylate; and based on a mass of the electrolyte, a mass percentage of the chain carboxylate is 6% to 56%. In this application, the coating weights of the positive electrode active material layer and the negative electrode active material layer, the separator, and the electrolyte are combined, and W_{z}, W_{f}, the mass percentage of the chain carboxylate, the average particle size of the first polymer binder, and the average particle size of the second polymer binder are adjusted within the above ranges, so that the coating weights of the positive electrode active material layer and the negative electrode active material layer, the separator, and the electrolyte can have a good synergistic effect. This is conducive to accelerating the transmission of ions and the infiltration of the electrolyte, and can also alleviate the problem of gas production caused by intensified interface side reactions between the electrolyte and the positive electrode sheet or the negative electrode sheet, thereby guaranteeing the cycling performance and high-temperature storage performance of the secondary battery under fast charging conditions.

Controlling the coating weights of the positive and negative electrode active material layers of the fast-charging secondary battery within the above ranges can reduce the thicknesses of the active material layers, increase the porosities of the active material layers, shorten a transmission distance of the electrolyte in the electrode sheet, accelerate the wetting of the electrode sheet, and improve the fast-charging performance. In addition, the mass percentage of the chain carboxylate in the electrolyte is adjusted within the above range, so that lithium ions have a faster transmission speed in the electrolyte, reducing the electrochemical polarization and concentration polarization of the secondary battery, reducing the impedance of the secondary battery, reducing the temperature rise during fast charging of the secondary battery, and shortening the charging time, thereby allowing the secondary battery to have good cycling performance and fast-charging performance. However, the high kinetic design makes side reactions easy to occur between the positive and negative electrode active materials and the electrolyte; especially under high temperature, intense side reactions occur to produce a large amount of gas, making the high-temperature performance of the battery poor. In this application, the first adhesive coating and the second adhesive coating are respectively provided on the two sides of the separator, and the average particle size of the first polymer binder in the first adhesive coating and the average particle size of the second polymer binder in the second adhesive coating are within the above ranges of this application, which is conducive to strengthening an interface between the separator and the electrode sheet, inhibiting the gas production under high-temperature conditions, and improving the cycling performance and high-temperature storage performance. An electrolyte flow channel can be formed in a side of the separator where the second adhesive coating is provided, and the electrolyte can be stored, meeting the requirements of the secondary battery for high electrolyte retention (such as 1.5 g/Ah to 2.4 g/Ah) and high transmission infiltration under a fast-charging state, and improving the rate performance and cycling performance of the secondary battery.

In some embodiments of this application, 6.49 mg/cm²≤W_{z}≤11.69 mg/cm². Adjusting the value of W_{z} within the above range can shorten transmission distances of ions and electrons on the positive electrode sheet, improving the infiltration speed of the electrolyte at the positive electrode sheet or the negative electrode sheet, and facilitating the transmission of ions, thereby improving the high-temperature storage performance of the secondary battery and further improving the cycling performance of the secondary battery.

In some embodiments of this application, the first adhesive coating is provided on a side of the separator substrate close to the negative electrode sheet, and the second adhesive coating is provided on a side of the separator substrate close to the positive electrode sheet. For the vast majority of secondary batteries, the main requirement is fast charging for energy replenishment, but there is no fast discharge demand, that is, a charging rate is much greater than a discharging rate. A charging process of the secondary battery mainly involves the intercalation of lithium ions into a negative electrode. Therefore, providing the first adhesive coating with small particles of the separator on a negative electrode sheet side can shorten a transmission path of lithium ions during the charging process and achieve a faster charging speed.

In some embodiments of this application, the chain carboxylate includes at least one of methyl formate, methyl acetate, ethyl formate, ethyl acetate, propyl acetate, ethyl propionate, methyl propionate, n-propyl propionate, isopropyl propionate, n-butyl propionate, isobutyl propionate, n-pentyl propionate, isopentyl propionate, ethyl n-butyrate, n-propyl n-butyrate, propyl isobutyrate, n-pentyl n-butyrate, n-pentyl isobutyrate, n-butyl n-butyrate, isobutyl isobutyrate, or n-pentyl n-valerate. The electrolyte including the above chain carboxylates has low viscosity and high conductivity, facilitating the transmission of ions, and further improving the cycling performance of the secondary battery while allowing the secondary battery to have good high-temperature storage performance.

In some embodiments of this application, the organic solvent further includes at least one of ethylene carbonate, propylene carbonate, dimethyl carbonate, diethyl carbonate, methyl ethyl carbonate, γ-butyrolactone, or tetrahydrofuran; and based on the mass of the electrolyte, a mass percentage of the organic solvent is 70% to 80%. The electrolyte including the above types of organic solvents can improve the stability of the electrolyte at high temperatures, thereby further improving the cycling performance and high-temperature storage performance of the secondary battery.

In some embodiments of this application, the lithium salt includes at least of lithium hexafluorophosphate, lithium difluorophosphate, lithium tetrafluoroborate, lithium hexafluoroarsenate, lithium perchlorate, lithium bis(fluorosulfonyl)imide, lithium bis(trifluoromethanesulfonyl)imide, lithium bis(oxalato)borate, or lithium difluoro(oxalato)borate; and based on the mass of the electrolyte, a mass percentage of the lithium salt is 10% to 20%. The electrolyte includes the lithium salt within the above range, and the mass percentage of the lithium salt is adjusted within the above range, so that the lithium salt has high solubility in the electrolyte, allowing the electrolyte to have high conductivity, thereby improving the cycling performance of the secondary battery.

In some embodiments of this application, the additive includes at least one of succinonitrile, glutaronitrile, pimelonitrile, 1,2-bis(2-cyanoethoxy)ethane, 1,2-bis(2-cyanoethoxy)propane, or 1,2,3-tris(2-cyanoethoxy)propane; and based on the mass of the electrolyte, a mass percentage of the additive is 2% to 10%. Adjusting the type and mass percentage of the additive within the above range is conducive to improving the stability of the positive electrode sheet and reducing side reactions in the electrolyte, thereby improving the cycling performance and high-temperature storage performance of the secondary battery.

In some embodiments of this application, based on the mass of the electrolyte, the mass percentage of the chain carboxylate is 18% to 40%. Adjusting the mass percentage of the chain carboxylate within the above range allows the electrolyte to have low viscosity and high conductivity, facilitating the transmission of ions, and further improving the cycling performance of the secondary battery while allowing the secondary battery to have good high-temperature storage performance.

In some embodiments of this application, a thickness of the first adhesive coating is 0.2 μm to 4 μm, and a thickness of the second adhesive coating is 5 μm to 20 μm. The adhesive coating with a small particle size has a high adhesion force, and its thickness is 0.2 μm to 4 μm. This can maximize the energy density under the high adhesion force and shorten the transmission path of lithium ions in the active material layer corresponding to the first adhesive coating. The second adhesive coating has a large particle size, so that an electrolyte flow channel may be formed. Setting the thickness of the second adhesive coating to be 5 μm to 20 μm can increase the energy density of the secondary battery on the premise that the electrolyte has good flow infiltration.

In some embodiments of this application, a single-side coating weight of the first adhesive coating is 0.0001 mg/mm² to 0.001 mg/mm², and a single-side coating weight of the second adhesive coating is 0.0004 mg/mm² to 0.002 mg/mm². Adjusting the single-side coating weight of the first adhesive coating within the above range can fully exert the high adhesion characteristic of the first adhesive coating, better bond the electrode sheet and the separator, and ensure the mechanical reliability of the secondary battery. Adjusting the single-side coating weight of the second adhesive coating within the above range can fully realize the electrolyte flow channel between the electrode sheet and the separator and improve the kinetic performance and cycling performance of the secondary battery.

In some embodiments of this application, a coverage rate of the first polymer binder in the first adhesive coating per unit area is 40% to 60%. Adjusting the coverage rate of the first polymer binder in the first adhesive coating per unit area within the above range can fully exert the high adhesion characteristic of the first adhesive coating, so that when the separator is bonded to the electrode sheet, lithium ions have a faster transmission speed, thereby allowing the secondary battery to guarantee the cycling performance and the high-temperature storage performance while having low production costs.

In some embodiments of this application, the first polymer binder includes a core-shell first polymer binder or a non-core-shell first polymer binder; a polymerized monomer of a core of the core-shell first polymer binder includes at least one of ethyl acrylate, butyl acrylate, ethyl methacrylate, styrene, chlorostyrene, fluorostyrene, methylstyrene, acrylic acid, methacrylic acid, or maleic acid; a polymerized monomer of a shell of the core-shell first polymer binder includes at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile; and a polymerized monomer of the non-core-shell first polymer binder includes at least one of acrylic acid, methyl acrylate, butyl acrylate, butadiene, styrene, acrylonitrile, ethylene, fluorostyrene, chlorostyrene, or propylene. Applying the above types of first polymer binders to the first adhesive coating allows the first adhesive coating to have a high adhesion force, thereby improving the cycling performance and high-temperature storage performance of the secondary battery.

In some embodiments of this application, a coverage rate of the second polymer binder in the second adhesive coating per unit area is 40% to 60%. Adjusting the coverage rate of the second polymer binder in the second adhesive coating per unit area within the above range allows for a high adhesion force between the separator and the positive electrode sheet or the negative electrode sheet, allowing the secondary battery to guarantee the cycling performance and the high-temperature storage performance while having low production costs.

In some embodiments of this application, a polymerized monomer of the second polymer binder includes at least one of vinylidene chloride, vinylidene fluoride, hexafluoropropylene, ethylene, propylene, vinyl chloride, chloropropene, acrylic acid, acrylate, styrene, butadiene, acrylonitrile, methyl acrylate, butyl acrylate, ethyl acrylate, chlorostyrene, fluorostyrene, ethyl methacrylate, methyl methacrylate, butyl methacrylate, or ethyl chloromethyl acrylate. Selecting the above types of second polymer binders allows for a large gap and high adhesion between the second adhesive coating and the positive electrode sheet or the negative electrode sheet, allowing for good heat dissipation during the cycling process, facilitating the transmission of the electrolyte, and allowing the secondary battery to have good cycling performance and high-temperature storage performance under fast charging conditions.

In some embodiments of this application, the second polymer binder includes a core-shell second polymer binder or a non-core-shell second polymer binder; a polymerized monomer of a shell of the core-shell second polymer binder includes at least one of vinylidene chloride, vinylidene fluoride, hexafluoropropylene, styrene, butadiene, acrylonitrile, acrylic acid, methyl acrylate, or butyl acrylate; a core of the core-shell second polymer binder includes at least one of methyl acrylate, butyl acrylate, ethyl acrylate, ethyl methacrylate, methyl methacrylate, butyl methacrylate, or ethyl chloromethyl acrylate; and a polymerized monomer of the non-core-shell second polymer binder includes at least one of acrylic acid, methyl acrylate, butyl acrylate, butadiene, styrene, acrylonitrile, ethylene, propylene, chlorostyrene, fluorostyrene, vinylidene chloride, vinylidene fluoride, hexafluoropropylene, vinyl chloride, or chloropropene. Selecting the above types of second polymer binders allows for a large gap and high adhesion between the second adhesive coating and the positive electrode sheet or the negative electrode sheet, allowing for good heat dissipation during the cycling process, and allowing the secondary battery to have good cycling performance and high-temperature storage performance under fast charging conditions.

According to a second aspect of this application, an electric apparatus is provided and including the secondary battery according to any one of the foregoing embodiments. The secondary battery provided by the first aspect of this application has good cycling performance and high-temperature storage performance. Therefore, the electric apparatus has good service performance.

The beneficial effects of this application are as follows:

This application provides a secondary battery and an electric apparatus. The coating weights of the positive electrode active material layer and the negative electrode active material layer, the separator, and the electrolyte are combined, and W_{z}, W_{f}, the mass percentage of the chain carboxylate, the average particle size of the first polymer binder, and the average particle size of the second polymer binder are adjusted within the ranges of this application, so that the coating weights of the positive electrode active material layer and the negative electrode active material layer, the separator, and the electrolyte can have a good synergistic effect. This is conducive to accelerating the transmission of ions and the infiltration of the electrolyte, and can also alleviate the problem of gas production caused by intensified interface side reactions between the electrolyte and the positive electrode sheet or the negative electrode sheet, thereby guaranteeing the cycling performance and high-temperature storage performance of the secondary battery under fast charging conditions. The electric apparatus of this application has good service performance.

### BRIEF DESCRIPTION OF DRAWINGS

The accompanying drawings described herein are used to provide a further understanding of this application and constitute a part of this application. The schematic embodiments and descriptions thereof of this application are used to explain this application and do not constitute an improper limitation on this application.

FIG. 1 is a schematic diagram of a positional relationship between a separator, a positive electrode sheet, and a negative electrode sheet according to an embodiment of this application;

FIG. 2 is a schematic diagram of a positional relationship between a separator, a positive electrode sheet, and a negative electrode sheet according to another embodiment of this application;

FIG. 3 is a schematic cross-sectional structural diagram of a separator along its thickness direction according to an embodiment of this application;

FIG. 4 is a schematic cross-sectional structural diagram of a separator along its thickness direction according to another embodiment of this application; and

FIG. 5 is a schematic cross-sectional structural diagram of a separator along its thickness direction according to still another embodiment of this application.

### REFERENCE SIGNS

separator 30, separator substrate 31, first adhesive coating 32, second adhesive coating 33, ceramic coating 34, positive electrode sheet 10, and negative electrode sheet 20.

### DETAILED DESCRIPTION

In order to make the objectives, technical solutions, and advantages of this application clearer, this application will be further described in detail below with reference to the accompanying drawings and embodiments. Apparently, the described embodiments are only some rather than all of these embodiments of this application. All other embodiments obtained by those skilled in the art based on this application are within the protection scope of this application.

It should be noted that in some embodiments of this application, an example in which a lithium-ion battery is used as a secondary battery is used to illustrate this application. However, the secondary battery in this application is not limited to the lithium-ion battery, and can also be applied to a secondary battery such as a sodium-ion battery.

According to a first aspect of this application, a secondary battery is provided and includes a positive electrode sheet, a negative electrode sheet, a separator, and an electrolyte. The positive electrode sheet includes a positive electrode active material layer. The negative electrode sheet includes a negative electrode active material layer. A coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm². For example, W_{f} may be 3.25 mg/cm², 3.5 mg/cm², 3.75 mg/cm², 4 mg/cm², 4.25 mg/cm², 4.5 mg/cm², 4.75 mg/cm², 5 mg/cm², 5.25 mg/cm², 5.5 mg/cm², 5.84 mg/cm², or a range defined by any two of these values. W_{z} may be 1.6W_{f}, 1.7W_{f}, 1.8W_{f}, 1.9W_{f}, 2.0W_{f}, 2.1W_{f}, 2.2W_{f}, or a range defined by any two of these values. The separator includes a separator substrate, a first adhesive coating, and a second adhesive coating. The first adhesive coating and the second adhesive coating are respectively provided on two sides of the separator substrate. The first adhesive coating includes a first polymer binder. An average particle size of the first polymer binder is 0.3 μm to 3 μm. For example, the average particle size of the first polymer binder may be 0.3 μm, 0.5 μm, 1 μm, 1.5 μm, 2 μm, 2.5 μm, 3 μm, or a range defined by any two of these values. The second adhesive coating includes a second polymer binder. An average particle size of the second polymer binder is 10 μm to 38 μm. For example, the average particle size of the second polymer binder may be 10 μm, 15 μm, 25 μm, 26 μm, 30 μm, 35 μm, 38 μm, or a range defined by any two of these values. The electrolyte includes an organic solvent, a lithium salt, and an additive. The organic solvent includes chain carboxylate. Based on a mass of the electrolyte, a mass percentage of the chain carboxylate is 6% to 56%, preferably 18% to 40%. For example, the mass percentage of the chain carboxylate may be 6%, 10%, 15%, 18%, 20%, 22%, 25%, 28%, 30%, 32%, 35%, 40%, 45%, 50%, 56%, or a range defined by any two of these values.

In this application, adjusting the values of W_{z} and W_{f} within the above ranges can shorten a transmission distance of ions (such as lithium ions) inside the positive electrode sheet or the negative electrode sheet, improving the infiltration speed of the electrolyte at the positive electrode sheet or the negative electrode sheet, and facilitating the transmission of ions, thereby improving the cycling performance of the secondary battery. The secondary battery includes the above electrolyte, and the mass percentage of the chain carboxylate is adjusted within the above range. The electrolyte has high conductivity and low viscosity, which can improve the ion transmission speed and reduce the electrochemical polarization and concentration polarization of the secondary battery, thereby allowing the secondary battery to have good cycling performance. However, a high kinetic system with the above characteristics will affect the high-temperature storage performance of the secondary battery. The secondary battery includes the above separator, and the average particle size of the first polymer binder and the average particle size of the second polymer binder are adjusted within the above ranges. This can enhance the adhesion force between the separator and the positive electrode sheet or the negative electrode sheet, alleviate the problem of gas production caused by intensified interface side reactions between the electrolyte and the positive electrode sheet or the negative electrode sheet, and improve the high-temperature storage performance of the secondary battery. In addition, the separator with the above characteristics can accelerate the transmission of the ions and the infiltration of the electrolyte, thereby guaranteeing the cycling performance and high-temperature storage performance of the secondary battery.

The inventors have found that when the coating weight of the positive electrode active material layer is less than 1.6W_{f}, the coating weight of the negative electrode active material layer is excessively large relative to the coating weight of the positive electrode active material layer. When the potential of the secondary battery is reached, a lithium deintercalation speed of the positive electrode active material increases significantly, causing the actual potential of the positive electrode active material to be extremely high and the structure to be easily damaged, making the capacity of the positive electrode sheet decay rapidly, and causing the secondary battery to fail to cycle normally. When the coating weight of the positive electrode active material layer is greater than 2.2W_{f}, the coating weight of the positive electrode active material layer is excessively large relative to the coating weight of the negative electrode active material layer, excessive lithium ions are deintercalated from a positive electrode, and a negative electrode cannot accept all the lithium ions deintercalated from the positive electrode, so that lithium ions cannot be normally intercalated into the negative electrode sheet, thereby causing lithium precipitation on the negative electrode sheet, and affecting the cycling kinetic performance of the secondary battery. When W_{f} is excessively large, for example, greater than 5.84 mg/cm², the transmission distance of ions inside the positive electrode sheet or the negative electrode sheet increases, and the impedance of the secondary battery increases, so that the transmission of lithium ions is not facilitated, and the cycling performance of the secondary battery cannot be improved. When W_{f} is excessively small, for example, less than 3.25 mg/cm², the energy density of the secondary battery decreases, and the service life is reduced, making it difficult to meet the application requirements of the secondary battery. When the average particle size of the first polymer binder is excessively small, for example, less than 0.3 μm, particles of the first polymer binder are prone to agglomeration when the first adhesive coating slurry is prepared. Thus, the probability that the first polymer binder is uniformly dispersed in the first adhesive coating slurry is extremely small, and the distribution of the first polymer binder in the formed first adhesive coating is uneven, thereby affecting the adhesion force of the first adhesive coating, failing to alleviate the problem of gas production caused by intensified interface side reactions between the electrolyte and the positive electrode sheet or the negative electrode sheet, and resulting in poor high-temperature storage performance of the secondary battery. When the average particle size of the first polymer binder is excessively large, for example, greater than 3 μm, gaps between the particles of the first polymer binder are excessively large, resulting in poor cycling performance. Moreover, the excessively large average particle size of the first polymer binder leads to an increased thickness of the first adhesive coating, thereby increasing the volume of the secondary battery and thus causing energy density loss of the secondary battery. When the average particle size of the second polymer binder is excessively small, for example, less than 10 μm, a gap between the separator and the positive electrode sheet or the negative electrode sheet is excessively small, and a transmission channel of the electrolyte is excessively narrow, affecting the transmission of the electrolyte, thereby affecting the cycling performance of the secondary battery. When the average particle size of the second polymer binder is excessively large, for example, greater than 38 μm, the thickness of the second adhesive coating is increased, thereby increasing the volume of the secondary battery and thus causing energy density loss of the secondary battery. The chain carboxylate has high conductivity and low viscosity, facilitating the transmission of lithium ions, and allowing the electrolyte to have high kinetic performance. When the mass percentage of the chain carboxylate is excessively small, for example, less than 6%, the amount of the chain carboxylate in the electrolyte is too small to fully exert its own characteristics, affecting the cycling performance of the secondary battery. When the mass percentage of the chain carboxylate is excessively large, for example, greater than 56%, the amount of the chain carboxylate in the electrolyte is excessively large, so that the activity of the electrolyte is excessively high, and especially under high temperature, the side reactions in the electrolyte are intensified, causing serious gas production problem of the secondary battery, thereby affecting the high-temperature cycling performance of the secondary battery. Overall, in this application, the coating weights of the positive electrode active material layer and the negative electrode active material layer, the separator, and the electrolyte are combined, and the above parameters are adjusted within the ranges of this application, so that the coating weights of the positive electrode active material layer and the negative electrode active material layer, the separator, and the electrolyte have a good synergistic effect, thereby guaranteeing the cycling performance and high-temperature storage performance of the secondary battery under fast charging conditions.

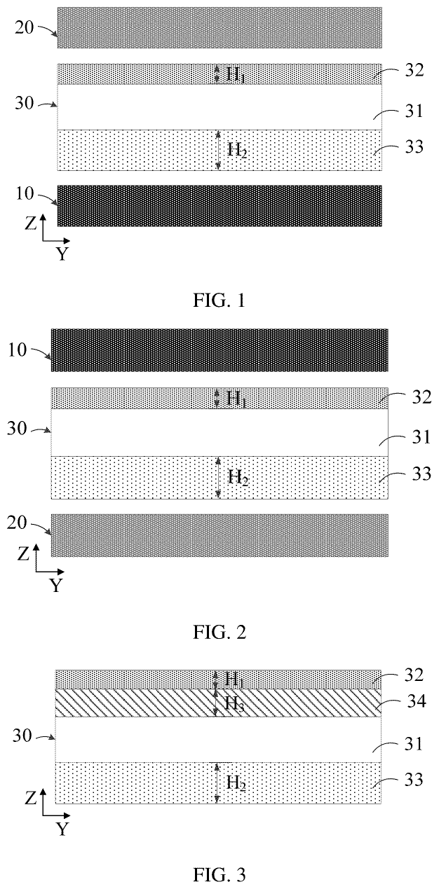

In this application, for ease of understanding, in an unfolded state of the separator, a width direction is defined as Y, and a thickness direction is defined as Z. It can be understood that length directions, width directions, and thickness directions of the positive electrode sheet and the negative electrode sheet in an unfolded state are the same as those of the separator. As shown in FIG. 1 and FIG. 2, a separator 30 includes a separator substrate 31, a first adhesive coating 32, and a second adhesive coating 33. The first adhesive coating 32 and the second adhesive coating 33 are respectively provided on two sides of the separator substrate 31. The separator substrate 31 is located between the first adhesive coating 32 and the second adhesive coating 33. The first adhesive coating 32 may be close to a side of the positive electrode sheet 10 or a side of the negative electrode sheet 20. As shown in FIG. 1, the first adhesive coating 32 is provided on a side of the separator substrate 31 close to the negative electrode sheet 20, and the second adhesive coating 33 is provided on a side of the separator substrate 31 close to the positive electrode sheet 10. As shown in FIG. 2, the first adhesive coating 32 is provided on the side of the separator substrate 31 close to the positive electrode sheet 10, and the second adhesive coating 33 is provided on the side of the separator substrate 31 close to the negative electrode sheet 20.

The secondary battery in this application can be used under fast charging conditions. Specifically, the secondary battery can be used at a charging rate of 5C to 15C. For example, the charging rate of the secondary battery is 5C, 8C, 10C, 12C, 15C, or a range defined by any two of these values.

In this application, the average particle size can be understood as an equivalent diameter. This application has no particular limitation on adjustment methods of the average particle size of the first polymer binder, the average particle size of the second polymer binder, and an average particle size of the ceramic particles, provided that the objectives of this application can be achieved. For example, the average particle size of the first polymer binder, the average particle size of the second polymer binder, and the average particle size of the ceramic particles can be adjusted by purchasing the first polymer binder, the second polymer binder, and ceramic particles with average particle sizes within the ranges of this application, or adjusted by crushing, grinding, or ball milling.

In some embodiments of this application, 6.49 mg/cm²≤W_{z}≤11.69 mg/cm². For example, W_{z} may be 6.49 mg/cm², 6.7 mg/cm², 7 mg/cm², 7.23 mg/cm², 7.5 mg/cm², 7.79 mg/cm², 8 mg/cm², 8.24 mg/cm², 8.5 mg/cm², 8.8 mg/cm², 9 mg/cm², 9.2 mg/cm², 9.5 mg/cm², 9.7 mg/cm², 10 mg/cm², 10.2 mg/cm², 10.5 mg/cm², 10.7 mg/cm², 11 mg/cm², 11.69 mg/cm², or a range defined by any two of these values. Adjusting the value of W_{z} within the above range can shorten transmission distances of ions and electrons on the positive electrode sheet, improving the infiltration speed of the electrolyte at the positive electrode sheet or the negative electrode sheet, and facilitating the transmission of ions, thereby improving the high-temperature storage performance of the secondary battery and further improving the cycling performance of the secondary battery.

In some embodiments of this application, the first adhesive coating is provided on the side of the separator substrate close to the negative electrode sheet, and the second adhesive coating is provided on the side of the separator substrate close to the positive electrode sheet. As shown in FIG. 1, the first adhesive coating 32 is provided on the side of the separator substrate 31 close to the negative electrode sheet 20, and the second adhesive coating 33 is provided on the side of the separator substrate 31 close to the positive electrode sheet 10. For the vast majority of secondary batteries, the main requirement is fast charging for energy replenishment, but there is no fast discharge demand, that is, a charging rate is much greater than a discharging rate. A charging process of the secondary battery mainly involves the intercalation of lithium ions into a negative electrode. Therefore, providing the first adhesive coating with smaller particles of the separator on a negative electrode sheet side can shorten a transmission path of lithium ions during the charging process and achieve a faster charging speed, and also facilitates high adhesion between the positive electrode sheet or the negative electrode sheet and the separator, thereby allowing the secondary battery to have good high-temperature storage performance.

In some embodiments of this application, the chain carboxylate includes at least one of methyl formate, methyl acetate, ethyl formate, ethyl acetate, propyl acetate, ethyl propionate, methyl propionate, n-propyl propionate, isopropyl propionate, n-butyl propionate, isobutyl propionate, n-pentyl propionate, isopentyl propionate, ethyl n-butyrate, n-propyl n-butyrate, propyl isobutyrate, n-pentyl n-butyrate, n-pentyl isobutyrate, n-butyl n-butyrate, isobutyl isobutyrate, or n-pentyl n-valerate. The electrolyte including the above chain carboxylates has low viscosity and high conductivity, facilitating the transmission of ions, and further improving the cycling performance of the secondary battery while allowing the secondary battery to have good high-temperature storage performance.

In some embodiments of this application, the organic solvent further includes at least one of ethylene carbonate, propylene carbonate, dimethyl carbonate, diethyl carbonate, methyl ethyl carbonate, γ-butyrolactone, or tetrahydrofuran; and based on the mass of the electrolyte, a mass percentage of the organic solvent is 70% to 80%. For example, the mass percentage of the organic solvent may be 70%, 72%, 75%, 78%, 80%, or a range defined by any two of these values. The electrolyte including the above types of organic solvents can improve the stability of the electrolyte at high temperatures and can also have excellent kinetic performance, thereby further improving the cycling performance and high-temperature storage performance of the secondary battery.

Typically, in this application, the mass percentage of the organic solvent can be adjusted by adjusting the amount of the organic solvent added to the electrolyte. In this application, the mass percentage of the chain carboxylate can be adjusted by adjusting the amount of the chain carboxylate added to the electrolyte. The mass percentage of non-chain carboxylate in the organic solvent is equal to the mass percentage of the organic solvent minus the mass percentage of the chain carboxylate. In this application, the non-chain carboxylate may be at least one of the above ethylene carbonate, propylene carbonate, dimethyl carbonate, diethyl carbonate, methyl ethyl carbonate, γ-butyrolactone, or tetrahydrofuran.

In some embodiments of this application, the lithium salt includes at least one of lithium hexafluorophosphate, lithium difluorophosphate, lithium tetrafluoroborate, lithium hexafluoroarsenate, lithium perchlorate, lithium bis(fluorosulfonyl)imide, lithium bis(trifluoromethanesulfonyl)imide, lithium bis(oxalato)borate, or lithium difluoro(oxalato)borate; and based on the mass of the electrolyte, a mass percentage of the lithium salt is 10% to 20%. For example, the mass percentage of the lithium salt may be 10%, 12%, 13%, 14%, 15%, 16%, 18%, 20%, or a range defined by any two of these values. The electrolyte includes the lithium salt within the above range, and the mass percentage of the lithium salt is adjusted within the above range, so that the lithium salt has high solubility in the electrolyte, allowing the electrolyte to have high conductivity, thereby improving the cycling performance of the secondary battery.

In some embodiments of this application, the additive includes at least one of succinonitrile, glutaronitrile, pimelonitrile, 1,2-bis(2-cyanoethoxy)ethane, 1,2-bis(2-cyanoethoxy)propane, or 1,2,3-tris(2-cyanoethoxy)propane; and based on the mass of the electrolyte, a mass percentage of the additive is 2% to 10%. For example, the mass percentage of the additive can be 2%, 3%, 5%, 7%, 8%, 9%, 10%, or a range defined by any two of these values. Adjusting the type and mass percentage of the additive within the above range can form a positive electrode solid electrolyte interface film (CEI film) on a surface of the positive electrode sheet, and is conducive to improving the stability of the positive electrode sheet, reducing the dissolution of transition metals in the positive electrode active material, improving the stability of the negative electrode active material, and reducing side reactions in the electrolyte, thereby improving the cycling performance and high-temperature storage performance of the secondary battery under fast charging conditions.

In an embodiment of this application, as shown in FIG. 1 and FIG. 2, a thickness H₁ of the first adhesive coating 32 is 0.2 μm to 4 μm. For example, the thickness H₁ of the first adhesive coating may be 0.2 μm, 0.5 μm, 1 μm, 1.5 μm, 2 μm, 2.5 μm, 3 μm, 3.5 μm, 4 μm, or a range defined by any two of these values. The particle size of the first polymer binder in the first adhesive coating is small, and the adhesion force of the first adhesive coating is high. Adjusting the thickness of the first adhesive coating within the above range allows the first adhesive coating to have an appropriate thickness, which can reduce the risk of energy density loss caused by the increase in the volume of the secondary battery due to the excessive thickness while exerting the high adhesion force of the first adhesive coating, thereby increasing the energy density of the fast-charging secondary battery, and shortening the transmission path of lithium ions in the active material layer corresponding to the first adhesive coating. Thus, the secondary battery can guarantee the cycling performance and high-temperature storage performance and also have a high energy density.

In this application, the thickness of the above first adhesive coating and the thickness of the second adhesive coating are obtained by observing and testing cross-sectional sample parameters of the separator. This application has no particular limitation on a preparation method of a cross-sectional sample of the separator, provided that the objectives of this application can be achieved. For example, the cross-section of the separator can be obtained by argon ion polishing or embedding sectioning.

In an embodiment of this application, as shown in FIG. 1 and FIG. 2, a thickness H₂ of the second adhesive coating 33 is 5 μm to 20 μm. For example, the thickness H₂ of the second adhesive coating may be 5 μm, 6 μm, 8 μm, 10 μm, 12 μm, 14 μm, 16 μm, 18 μm, 20 μm, or a range defined by any two of these values. The particle size of the second polymer binder in the second adhesive coating is large, so that an electrolyte flow channel may be formed. Setting the thickness of the second adhesive coating within the above range allows the second adhesive coating to have an appropriate thickness, which can reduce the risk of energy density loss caused by the increase in the volume of the secondary battery due to the excessive thickness when the electrolyte has good flow infiltration in the electrode sheet and the separator, thereby allowing the secondary battery to guarantee the cycling performance and high-temperature storage performance while having a high energy density.

In an embodiment of this application, a single-side coating weight of the first adhesive coating is 0.0001 mg/mm² to 0.001 mg/mm². For example, the single-side coating weight of the first adhesive coating may be 0.0001 mg/mm², 0.0004 mg/mm², 0.0005 mg/mm², 0.0007 mg/mm², 0.0009 mg/mm², 0.001 mg/mm², or a range defined by any two of these values. Adjusting the single-side coating weight of the first adhesive coating within the above range allows the first adhesive coating to better bond the positive electrode sheet or the negative electrode sheet and the separator while exerting its high adhesion, and can also reduce the risk of energy density loss caused by the increase in the volume of the secondary battery due to the excessive single-side coating weight, thereby allowing the secondary battery to guarantee the cycling performance and the high-temperature storage performance while having a high energy density.

In an embodiment of this application, a single-side coating weight of the second adhesive coating is 0.0004 mg/mm² to 0.002 mg/mm². For example, the single-side coating weight of the second adhesive coating may be 0.0004 mg/mm², 0.0008 mg/mm², 0.001 mg/mm², 0.0012 mg/mm², 0.0015 mg/mm², 0.0018 mg/mm², 0.002 mg/mm², or a range defined by any two of these values. Adjusting the single-side coating weight of the first adhesive coating within the above range can fully realize the electrolyte flow channel between the positive electrode sheet or the negative electrode sheet and the separator and improve the kinetic performance and cycling performance of the secondary battery, and can also reduce the risk of energy density loss caused by the increase in the volume of the secondary battery due to the excessive single-side coating weight, thereby allowing the secondary battery to guarantee the cycling performance and the high-temperature storage performance while having a high energy density.

In some embodiments of this application, a coverage rate Cr₁ of the first polymer binder in the first adhesive coating per unit area is 40% to 60%. For example, Cr₁ may be 40%, 42%, 44%, 46%, 48%, 50%, 52%, 54%, 56%, 58%, 60%, or a range defined by any two of these values. Adjusting the coverage rate of the first polymer binder in the first adhesive coating per unit area within the above range allows the first polymer binder to exert its high adhesion force, fully exerting the high adhesion characteristic of the first adhesive coating, and facilitating the transmission of lithium ions under the condition of bonding the separator and the electrode sheet, thereby allowing the secondary battery to guarantee the cycling performance and the high-temperature storage performance while having good kinetic performance.

In some embodiments of this application, the first polymer binder includes a core-shell first polymer binder or a non-core-shell first polymer binder; a polymerized monomer of a core of the core-shell first polymer binder includes at least one of ethyl acrylate, butyl acrylate, ethyl methacrylate, styrene, chlorostyrene, fluorostyrene, methylstyrene, acrylic acid, methacrylic acid, or maleic acid; a polymerized monomer of a shell of the core-shell first polymer binder includes at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile; and a polymerized monomer of the non-core-shell first polymer binder includes at least one of acrylic acid, methyl acrylate, butyl acrylate, butadiene, styrene, acrylonitrile, ethylene, fluorostyrene, chlorostyrene, or propylene. Applying the above types of first polymer binders to the first adhesive coating allows the first adhesive coating have a high adhesion force, thereby improving the cycling performance and high-temperature storage performance of the secondary battery.

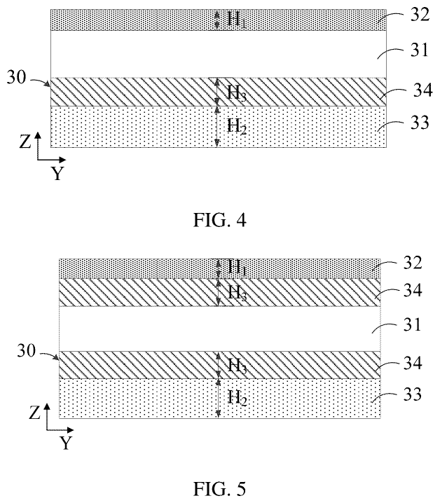

In this application, the separator may further include a ceramic coating, where the ceramic coating is provided between the separator substrate and the first adhesive coating, and/or the ceramic coating is provided between the separator substrate and the second adhesive coating. In some embodiments, as shown in FIG. 3, the separator 30 includes a separator substrate 31, a first adhesive coating 32, a second adhesive coating 33, and a ceramic coating 34. The first adhesive coating 32 and the second adhesive coating 33 are respectively provided on two sides of the separator substrate 31. The ceramic coating 34 is provided between the separator substrate 31 and the first adhesive coating 32. The second adhesive coating 33 is adjacent to a surface of the separator substrate 31 away from the ceramic coating 34. In some other embodiments, as shown in FIG. 4, the separator 30 includes a separator substrate 31, a first adhesive coating 32, a second adhesive coating 33, and a ceramic coating 34. The first adhesive coating 32 and the second adhesive coating 33 are respectively provided on two sides of the separator substrate 31. The ceramic coating 34 is provided between the separator substrate 31 and the second adhesive coating 33. The first adhesive coating 32 is adjacent to a surface of the separator substrate 31 away from the ceramic coating 34. In still some other embodiments, as shown in FIG. 5, the separator 30 includes a separator substrate 31, a first adhesive coating 32, a second adhesive coating 33, and two ceramic coatings 34. The first adhesive coating 32 and the second adhesive coating 33 are respectively provided on two sides of the separator substrate 31. One ceramic coating 34 is provided between the separator substrate 31 and the first adhesive coating 32, and the other ceramic coating 34 is provided between the separator substrate 31 and the second adhesive coating 33.

It should be noted that the above two ceramic coatings may be the same or different. The ceramic coating has good hardness and heat resistance. Providing the ceramic coating in the separator can improve the hardness and heat resistance of the secondary battery, thereby allowing the secondary battery to have good thermal safety performance and mechanical reliability while having good kinetic performance and cycling performance. This application has no particular limitation on the thickness of the ceramic coating. For example, the thickness of the ceramic coating may be 0.5 μm to 6 μm. The ceramic coating includes ceramic particles and a ceramic coating binder. This application has no particular limitation on the type of the ceramic coating binder, provided that the objectives of this application can be achieved. For example, the ceramic coating binder includes but is not limited to at least one of polyvinylidene fluoride, polyacrylic acid, polymethyl methacrylate, polybutyl acrylate, or polyacrylonitrile. This application has no particular limitation on the amounts of the ceramic particles and the ceramic coating binder in the ceramic coating, provided that the objectives of this application can be achieved. For example, based on a mass of the ceramic coating, a mass percentage of the ceramic particles is 5% to 95%, and a mass percentage of the ceramic coating binder is 5% to 95%. This application has no particular limitation on the separator substrate, provided that the objectives of this application can be achieved. For example, the structure of the separator substrate includes a single-layer structure or a multi-layer composite structure, where the multi-layer composite structure may be a two-layer composite structure, a three-layer composite structure, or a four-layer composite structure. The type of the separator substrate includes at least one of polyethylene (PE), polypropylene (PP), or polyethylene terephthalate (PET). A thickness of the separator substrate may be 3 μm to 20 μm.

In this application, the first adhesive coating includes a first polymer binder and may further include a thickener, an auxiliary binder, and a wetting agent. The thickener applied to the first adhesive coating can improve the stability of a first adhesive coating slurry and prevent the settling of various components in the first adhesive coating slurry. The auxiliary binder applied to the first adhesive coating can bond the first polymer binder to the separator substrate and the ceramic coating during a coating process of the first adhesive coating slurry. The wetting agent applied to the first adhesive coating can reduce the surface energy of the first adhesive coating slurry and prevent omission of coating during the coating process of the first adhesive coating slurry. This application has no particular limitation on the amounts of the first polymer binder, the thickener, the auxiliary binder, and the wetting agent in the first adhesive coating, provided that the objectives of this application can be achieved. For example, based on a mass of the first adhesive coating, a mass percentage of the first polymer binder may be 85% to 95%, a mass percentage of the thickener may be 0.5% to 2%, a mass percentage of the auxiliary binder may be 0% to 15%, and a mass percentage of the wetting agent may be 4% to 10%. This application has no particular limitation on the types of the above thickener, the auxiliary binder, and the wetting agent, provided that the objectives of this application can be achieved. For example, the thickener includes but is not limited to sodium carboxymethyl cellulose. The auxiliary binder includes but is not limited to a homopolymer or copolymer polymerized from at least one of the following monomers: ethyl acrylate, butyl acrylate, ethyl methacrylate, acrylic acid, methacrylic acid, maleic anhydride, dicarboxylic anhydride, acrylonitrile, butadiene, and a monovinyl compound. This application has no particular limitation on the type of the above monovinyl compound, provided that the objectives of this application can be achieved. For example, the monovinyl compound includes but is not limited to at least one of styrene, chlorostyrene, fluorostyrene, or methylstyrene. The wetting agent may include but is not limited to sodium carboxymethyl cellulose, dimethylsiloxane, polyoxyethylene dimethylsiloxane, polyethylene oxide, oxyethylene alkylphenol ether, polyoxyethylene fatty alcohol ether, polyoxyethylene-polyoxypropylene block copolymer, and sodium dioctyl sulfosuccinate.

In some embodiments of this application, a coverage rate Cr₂ of the second polymer binder in the second adhesive coating per unit area is 40% to 60%. For example, Cr₂ may be 40%, 42%, 44%, 46%, 48%, 50%, 52%, 54%, 56%, 58%, 60%, or a range defined by any two of these values. The coverage rate of the second polymer binder in the second adhesive coating per unit area is adjusted within the above range, so that when the second polymer binder allows for a large gap between the second adhesive coating and the positive electrode sheet or between the second adhesive coating and the negative electrode sheet, a wider electrolyte transmission channel can be provided during the cycling process, and thus the electrolyte has good flow infiltration in the positive electrode sheet, the negative electrode sheet, and the separator, allowing the second adhesive coating to have an appropriate thickness, thereby reducing the risk of energy density loss caused by the increase in the volume of the fast-charging secondary battery due to the excessive thickness, and allowing the secondary battery to have a high energy density while guaranteeing the cycling performance and the high-temperature storage performance.

In some embodiments of this application, a polymerized monomer of the second polymer binder includes at least one of vinylidene chloride, vinylidene fluoride, hexafluoropropylene, ethylene, propylene, vinyl chloride, chloropropene, acrylic acid, acrylate, styrene, butadiene, acrylonitrile, methyl acrylate, butyl acrylate, ethyl acrylate, chlorostyrene, fluorostyrene, ethyl methacrylate, methyl methacrylate, butyl methacrylate, or ethyl chloromethyl acrylate. Selecting the above types of second polymer binders allows for a large gap and high adhesion between the second adhesive coating and the positive electrode sheet or the negative electrode sheet, so that the electrolyte has good flow infiltration in the positive electrode sheet, the negative electrode sheet, and the separator, facilitating the transmission of the electrolyte, and allowing the secondary battery to have good cycling performance and high-temperature storage performance under fast charging conditions.

In some embodiments of this application, the second polymer binder includes a core-shell second polymer binder or a non-core-shell second polymer binder; a polymerized monomer of a shell of the core-shell second polymer binder includes at least one of vinylidene chloride, vinylidene fluoride, hexafluoropropylene, styrene, butadiene, acrylonitrile, acrylic acid, methyl acrylate, or butyl acrylate; a core of the core-shell second polymer binder includes at least one of methyl acrylate, butyl acrylate, ethyl acrylate, ethyl methacrylate, methyl methacrylate, butyl methacrylate, or ethyl chloromethyl acrylate; and a polymerized monomer of the non-core-shell second polymer binder includes at least one of acrylic acid, methyl acrylate, butyl acrylate, butadiene, styrene, acrylonitrile, ethylene, propylene, chlorostyrene, fluorostyrene, vinylidene chloride, vinylidene fluoride, hexafluoropropylene, vinyl chloride, or chloropropene. Selecting the above types of second polymer binders allows for a large gap and high adhesion between the second adhesive coating and the positive electrode sheet or the negative electrode sheet. In addition, the electrolyte has good flow infiltration in the positive electrode sheet, the negative electrode sheet, and the separator, facilitating the transmission of the electrolyte, and allowing the secondary battery to have good cycling performance and high-temperature storage performance under fast charging conditions.

In this application, the second adhesive coating includes a second polymer binder and may further include an auxiliary binder. The auxiliary binder applied to the second adhesive coating can bond the second polymer binder to the separator substrate and/or the ceramic coating during a coating process of a second adhesive coating slurry. This application has no particular limitation on the type of the auxiliary binder, provided that the objectives of this application can be achieved. For example, the auxiliary binder may be the same as the auxiliary binder in the above first adhesive coating. This application has no particular limitation on the amounts of the second polymer binder and the auxiliary binder in the second adhesive coating, provided that the objectives of this application can be achieved. For example, based on a mass of the second adhesive coating, a mass percentage of the second polymer binder is 85% to 95%, and a mass percentage of the auxiliary binder is 5% to 15%.

The positive electrode sheet of this application includes a positive electrode current collector and a positive electrode active material layer provided on at least one surface of the positive electrode current collector. In some embodiments, the positive electrode active material layer is provided on one surface of the positive electrode current collector. In some other embodiments, the positive electrode active material layer is provided on two surfaces of the positive electrode current collector. The above “surface” may be a partial surface or an entire surface of the positive electrode current collector. This application has no particular limitation on the positive electrode current collector, provided that the objectives of this application can be achieved. For example, the positive electrode current collector may include an aluminum foil, an aluminum alloy foil, or a composite current collector (such as an aluminum-carbon composite current collector). The positive electrode active material layer of this application includes a positive electrode active material. This application has no particular limitation on the type of the positive electrode active material, provided that the objectives of this application can be achieved. For example, the positive electrode active material may include at least one of lithium nickel cobalt manganese oxide (NCM811, NCM622, NCM523, or NCM111), lithium nickel cobalt aluminum oxide, lithium iron phosphate, a lithium-rich manganese-based material, lithium cobalt oxide, lithium manganese oxide, lithium manganese iron phosphate, or lithium titanate. In this application, the positive electrode active material may further include a non-metal element. For example, the non-metal element includes at least one of fluorine, phosphorus, boron, chlorine, silicon, or sulfur. This application has no particular limitation on the thicknesses of the positive electrode current collector and the positive electrode active material layer, provided that the objectives of this application can be achieved. For example, the thickness of the positive electrode current collector is 5 μm to 20 μm, preferably 6 μm to 18 μm. The thickness of the single-side positive electrode material layer is 30 μm to 120 μm. In this application, the positive electrode active material layer may further include a positive electrode conductive agent and a positive electrode binder. This application has no particular limitation on the type of the positive electrode binder in the positive electrode active material layer, provided that the objectives of this application can be achieved. For example, the positive electrode binder may include but is not limited to at least one of polyvinylidene fluoride, a vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, or polyhexafluoropropylene. This application has no particular limitation on the type of the positive electrode conductive agent in the positive electrode active material layer, provided that the objectives of this application can be achieved. For example, the positive electrode conductive agent may include but is not limited to at least one of conductive carbon black (Super P), carbon nanotubes (CNTs), carbon fiber, flake graphite, Ketjen black, graphene, a metal material, or a conductive polymer. The above carbon nanotubes may include but are not limited to single-walled carbon nanotubes and/or multi-walled carbon nanotubes. The above carbon fiber may include but is not limited to vapor-grown carbon fiber (VGCF) and/or nano carbon fiber. The above metal material may include but is not limited to metal powder and/or metal fiber. Specifically, the metal may include but is not limited to at least one of copper, nickel, aluminum, or silver. The above conductive polymer may include but is not limited to at least one of a polyphenyl derivative, polyaniline, polythiophene, polyacetylene, or polypyrrole. This application has no particular limitation on a mass ratio of the positive electrode active material, the positive electrode conductive agent, and the positive electrode binder in the positive electrode active material layer. Those skilled in the art can select according to actual needs, provided that the objectives of this application can be achieved. For example, the mass ratio of the positive electrode active material, the positive electrode conductive agent, and the positive electrode binder in the positive electrode active material layer is (95 to 98):(0.5 to 2.5):(1.5 to 3.4).

The negative electrode sheet of this application includes a negative electrode current collector and a negative electrode active material layer provided on at least one surface of the negative electrode current collector. In some embodiments, the negative electrode active material layer is provided on one surface of the negative electrode current collector. In some other embodiments, the negative electrode active material layer is provided on two surfaces of the negative electrode current collector. The above “surface” may be a partial surface or an entire surface of the surface of the negative electrode current collector. This application has no particular limitation on the negative electrode current collector, provided that the objectives of this application can be achieved. For example, the negative electrode current collector may include a copper foil, a copper alloy foil, a nickel foil, a stainless steel foil, a titanium foil, foamed nickel, foamed copper, or a composite current collector (for example, a lithium-copper composite current collector, a carbon-copper composite current collector, a nickel-copper composite current collector, or a titanium-copper composite current collector). The negative electrode active material layer of this application includes a negative electrode active material. This application has no particular limitation on the type of the negative electrode active material, provided that the objectives of this application can be achieved. For example, the negative electrode active material may include at least one of natural graphite, artificial graphite, mesocarbon microbeads (MCMB), hard carbon, soft carbon, silicon, a silicon-carbon composite, SiOₓ (0<x<2), Li—Sn alloy, Li—Sn—O alloy, Sn, SnO, SnO₂, spinel-structured lithium titanate Li₄Ti₅O₁₂, Li—Al alloy, or metal lithium. This application has no particular limitation on the thicknesses of the negative electrode current collector and the negative electrode material layer, provided that the objectives of this application can be achieved. For example, the thickness of the negative electrode current collector is 4 μm to 20 μm, and the thickness of the negative electrode active material layer is 30 μm to 130 μm. Optionally, the negative electrode active material layer may further include a negative electrode conductive agent and a negative electrode binder. This application has no particular limitation on the type of the conductive agent in the negative electrode active material layer, provided that the objectives of this application can be achieved. For example, the negative electrode conductive agent may be of the same type as the positive electrode conductive agent in the above positive electrode active material layer. This application has no particular limitation on the type of the negative electrode binder in the negative electrode active material layer, provided that the objectives of this application can be achieved. For example, the negative electrode binder may be of the same type as the positive electrode binder in the above positive electrode active material layer. Optionally, the negative electrode active material layer may further include a stabilizer. This application has no particular limitation on the type of the stabilizer. For example, the stabilizer may include sodium carboxymethyl cellulose. This application has no particular limitation on a mass ratio of the negative electrode active material, the negative electrode conductive agent, and the negative electrode binder in the negative electrode active material layer, provided that the objectives of this application can be achieved. For example, the mass ratio of the negative electrode active material, the negative electrode conductive agent, the stabilizer, and the negative electrode binder in the negative electrode active material layer may be (96 to 98):(0.5 to 2):(0 to 1.5):(1.0 to 1.9).

In an embodiment of this application, the secondary battery further includes a housing. An electrode assembly and the electrolyte are accommodated in the housing. This application has no particular limitation on the housing which may be a housing well-known in the art, provided that the objectives of this application can be achieved. For example, the housing includes but is not limited to an aluminum-plastic film and a steel shell.

This application has no particular limitation on the type of the secondary battery, and the secondary battery may include any apparatus in which electrochemical reactions take place. For example, the secondary battery may include but is not limited to: a lithium metal secondary battery, a lithium-ion secondary battery (lithium-ion battery), a sodium-ion secondary battery (sodium-ion battery), a lithium polymer secondary battery, or a lithium-ion polymer secondary battery.

This application has no particular limitation on a preparation method of the positive electrode sheet, provided that the objectives of this application can be achieved. For example, the preparation method of the positive electrode sheet includes but is not limited to the following steps: (1) preparing a positive electrode slurry; (2) applying the positive electrode slurry on one surface of a positive electrode body region of the positive electrode current collector, drying, and then forming a positive electrode active material layer on one surface of the positive electrode body region of the positive electrode current collector; (3) applying the positive electrode slurry on another surface of the positive electrode body region of the positive electrode current collector, drying, and then forming positive electrode active material layers on two surfaces of the positive electrode body region of the positive electrode current collector respectively; and (4) cold pressing, cutting, and slitting to obtain the positive electrode sheet. This application has no particular limitation on the solid content of the positive electrode slurry in the above step (1), provided that a coating weight of the obtained positive electrode active material layer is within the range of this application and the objectives of this application can be achieved. For example, the solid content of the positive electrode slurry is 70 wt % to 80 wt %. This application has no particular limitation on the drying time and temperature in the above steps (2) and (3), provided that the objectives of this application can be achieved. This application has no particular limitation on process parameters of cold pressing in the above step (4), provided that the objectives of this application can be achieved.

This application has no particular limitation on a preparation method of the negative electrode sheet, provided that the objectives of this application can be achieved. For example, the preparation method of the negative electrode sheet includes but is not limited to the following steps: (1) preparing a negative electrode slurry; (2) applying the negative electrode slurry on one surface of a negative electrode body region of the negative electrode current collector, drying, and then forming a negative electrode active material layer on one surface of the negative electrode body region of the negative electrode current collector; (3) applying the negative electrode slurry on another surface of the negative electrode body region of the negative electrode current collector, drying, and then forming negative electrode active material layers on two surfaces of the negative electrode body region of the negative electrode current collector respectively; (4) cold pressing, cutting, and slitting to obtain the negative electrode sheet. This application has no particular limitation on the solid content of the negative electrode slurry in the above step (1), provided that a coating weight of the obtained negative electrode active material layer is within the range of this application and the objectives of this application can be achieved. For example, the solid content of the negative electrode slurry is 40 wt % to 60 wt %. This application has no particular limitation on the drying time and temperature in the above steps (2) and (3), provided that the objectives of this application can be achieved. This application has no particular limitation on process parameters of cold pressing in the above step (4), provided that the objectives of this application can be achieved.

This application has no particular limitation on a preparation method of the separator, provided that the objectives of this application can be achieved.

For example, in an embodiment, the preparation method of the separator includes but is not limited to the following steps: (1) mixing the first polymer binder, the thickener, the auxiliary binder, and the wetting agent well to obtain a first adhesive coating slurry; (2) mixing the second polymer binder and the auxiliary binder well to obtain a second adhesive coating slurry; and (3) applying the first adhesive coating slurry on one surface of the separator substrate, drying, and then forming a first adhesive coating on one surface of the separator substrate; and applying the second adhesive coating slurry on another surface of the separator substrate, drying, and then forming a second adhesive coating on the another surface of the separator substrate to obtain the separator.

For example, in another embodiment, the preparation method of the separator includes but is not limited to the following steps: (1) mixing the first polymer binder, the thickener, the auxiliary binder, and the wetting agent well to obtain a first adhesive coating slurry; (2) mixing the second polymer binder and the auxiliary binder well to obtain a second adhesive coating slurry; (3) mixing the ceramic particles and the ceramic coating binder well to obtain a ceramic coating slurry; and (4) applying the ceramic coating slurry on one surface of the separator substrate, drying, and then forming a ceramic coating on one surface of the separator substrate; applying the first adhesive coating slurry on the surface of the ceramic coating, drying, and then forming a first adhesive coating on a surface of the ceramic coating away from the separator substrate; and applying the second adhesive coating slurry on another surface of the separator substrate, drying, and then forming a second adhesive coating on the another surface of the separator substrate to obtain the separator.

For example, in still another embodiment, the preparation method of the separator includes but is not limited to the following steps: (1) mixing the first polymer binder, the thickener, the auxiliary binder, and the wetting agent well to obtain a first adhesive coating slurry; (2) mixing the second polymer binder and the auxiliary binder well to obtain a second adhesive coating slurry; (3) mixing the ceramic particles and the ceramic coating binder well to obtain a ceramic coating slurry; and (4) applying the ceramic coating slurry on one surface of the separator substrate, drying, and then forming a ceramic coating on one surface of the separator substrate; applying the second adhesive coating slurry on a surface of the ceramic coating, drying, and then forming a second adhesive coating on a surface of the ceramic coating away from the separator substrate; and applying the first adhesive coating slurry on another surface of the separator substrate, drying, and then forming a first adhesive coating on the another surface of the separator substrate to obtain the separator.

For example, in yet still another embodiment, the preparation method of the separator includes but is not limited to the following steps: (1) mixing the first polymer binder, the thickener, the auxiliary binder, and the wetting agent well to obtain a first adhesive coating slurry; (2) mixing the second polymer binder and the auxiliary binder well to obtain a second adhesive coating slurry; (3) mixing the ceramic particles and the ceramic coating binder well to obtain a ceramic coating slurry; and (4) applying the ceramic coating slurry on one surface of the separator substrate, drying, and then forming a ceramic coating on one surface of the separator substrate; applying the ceramic coating slurry on another surface of the separator substrate, drying, and then forming a ceramic coating on another surface of the separator substrate; applying the second adhesive coating slurry on a surface of the first ceramic coating away from the separator substrate, drying, and then forming a second adhesive coating on the surface of the first ceramic coating away from the separator substrate; and applying the first adhesive coating slurry on the surface of the second ceramic coating away from the separator substrate, drying, and then forming a first adhesive coating on the surface of the second ceramic coating away from the separator substrate to obtain the separator.

This application has no particular limitation on the solid content of the above first adhesive coating slurry, provided that the objectives of this application can be achieved. For example, the solid content of the first adhesive coating slurry is 60 wt % to 80 wt %. This application has no particular limitation on the solid content of the above second adhesive coating slurry, provided that the objectives of this application can be achieved. For example, the solid content of the second adhesive coating slurry is 60 wt % to 80 wt %. This application has no particular limitation on the solid content of the above ceramic coating slurry, provided that the objectives of this application can be achieved. For example, the solid content of the ceramic coating slurry is 30 wt % to 40 wt %. This application has no particular limitation on the above drying temperature and time. Those skilled in the art can select and adjust according to actual needs, provided that the objectives of this application can be achieved.

This application has no particular limitation on a preparation method of the secondary battery, and a preparation method well-known in the art can be selected, provided that the objectives of this application can be achieved. For example, the preparation method of the secondary battery includes but is not limited to the following steps: stacking the separator, the positive electrode sheet, the separator, and the negative electrode sheet in sequence, and performing operations such as winding and folding the resulting stack as needed to obtain an electrode assembly with a wound structure, placing the electrode assembly into the housing, injecting the electrolyte into the housing, and sealing to obtain the secondary battery; or stacking the separator, the positive electrode sheet, the separator, and the negative electrode sheet in sequence, fixing four corners of an entire laminated structure to obtain an electrode assembly with a laminated structure, placing the electrode assembly into the housing, injecting the electrolyte into the housing, and sealing to obtain the secondary battery.

According to a second aspect of this application, an electric apparatus is provided and includes the secondary battery according to any one of the foregoing embodiments. The secondary battery according to the first aspect of this application has good cycling performance and high-temperature storage performance. Therefore, the electric apparatus has good service performance.

The electric apparatus of this application is not particularly limited and may be any electric apparatus known in the prior art. For example, the electric apparatus may include but is not limited to: a notebook computer, a pen-input computer, a mobile computer, an e-book player, a portable phone, a portable fax machine, a portable copier, a portable printer, a head-mounted stereo headphone, a video recorder, a liquid crystal television, a portable cleaner, a portable CD player, a mini disc, a transceiver, an electronic notebook, a calculator, a storage card, a portable recorder, a radio, a backup power source, a motor, an automobile, a motorcycle, an electric bicycle, a bicycle, a lighting fixture, a toy, a game console, a clock, an electric tool, a flashlight, a camera, a large household storage battery, and a lithium-ion capacitor.

### EXAMPLES

The following describes some embodiments of this application more specifically by using examples and comparative examples. Various tests and evaluations are carried out according to the following methods. In addition, unless otherwise specified, “part” and “%” are based on mass.

### Test Methods and Devices:

### Test of Coating Weight W_{z} of Positive Electrode Active Material Layer:

After discharged at 0.5C to 3.0 V, a lithium-ion battery in each of examples and comparative examples was disassembled to obtain a positive electrode sheet. The positive electrode sheet was soaked in a dimethyl carbonate (DMC) solution for 4 h, and then dried. A positive electrode sheet sample with an area of A mm² was cut and weighed on a balance, with the weight recorded as p₁. Then, a positive electrode active material layer on the positive electrode sheet was scraped off and cleaned to obtain a positive electrode current collector. The positive electrode current collector was weighed on the balance, with the weight recorded as p₂. If the positive electrode sheet was a positive electrode sheet having one surface coated with the positive electrode active material layer, W_{z}=(p₁−p₂)/A. If the positive electrode sheet was a positive electrode sheet having two surfaces coated with positive electrode active material layers, W_{z}=(p₁−p₂)/2A.

### Test of Coating Weight W_{f} of Negative Electrode Active Material Layer:

After discharged at 0.5C to 3.0 V, a lithium-ion battery in each of examples and comparative examples was disassembled to obtain a negative electrode sheet. The negative electrode sheet was soaked in a DMC solution for 4 h, and then dried. A negative electrode sheet sample with an area of B mm² was cut and weighed on a balance, with the weight recorded as q₁. Then, a negative electrode active material layer on the negative electrode sheet was scraped off and cleaned to obtain a negative electrode current collector. The negative electrode current collector was weighed on the balance, with the weight recorded as q₂. If the negative electrode sheet was a negative electrode sheet having one surface coated with the negative electrode active material layer, W_{f}=(q₁−q₂)/B. If the negative electrode sheet was a negative electrode sheet having two surfaces coated with negative electrode active material layers, W_{f}=(q₁−q₂)/2B.

### Test of Average Particle Size:

For average particle sizes of a first polymer binder and a second polymer binder, a surface of a separator perpendicular to a thickness direction could be observed using a scanning electron microscopy (SEM), diameters of 10 first polymer binder particles and 10 second polymer binder particles were measured respectively, and an average was obtained. The first polymer binder and the second polymer binder were distinguished by the diameters of the particles. Specifically, in the surface of the separator, a side with particles having relatively small diameters was a first adhesive coating containing the first polymer binder, and 10 first polymer binders were arbitrarily selected in the first adhesive coating to obtain an average particle size of the first polymer binder. A side with particles having relatively large diameters was a second adhesive coating containing the second polymer binder, and 10 second polymer binders were arbitrarily selected in the second adhesive coating to obtain an average particle size of the second polymer binder. Since the particles of the first polymer binder and the second polymer binder deformed under the pressure in the cold pressing, hot pressing, and other processes during the preparation of the secondary battery, the diameters of the particles along the thickness direction of the separator and perpendicular to the thickness direction of the separator were different. The average particle sizes of the first polymer binder and the second polymer binder of this application were the diameters of the particles measured on the surface perpendicular to the thickness direction of the separator. Therefore, the above average particle sizes of the first polymer binder and the second polymer binder were not limited by the thicknesses of the first adhesive coating and the second adhesive coating.

### Test of Single-Side Coating Weight of First Adhesive Coating:

After discharged at 0.5C to 3.0 V, a lithium-ion battery in each of examples and comparative examples was disassembled to obtain a separator. After the impurities on the surface of the separator was cleaned with DMC, the separator was dried at 60° C. to obtain a test sample of the separator. A small disc with an area of S mm² was punched on the test sample of the separator, the mass of the small disc was weighed and recorded as m₁. Then, a first adhesive coating on the small disc was peeled off to obtain a mass of the small disc after the first adhesive coating was peeled off, where the mass was recorded as m₂. A single-side coating weight of the first adhesive coating was equal to (m₁−m₂)/S.

### Test of Single-Side Coating Weight of Second Adhesive Coating:

After discharged at 0.5C to 3.0 V, a lithium-ion battery in each of examples and comparative examples was disassembled to obtain a separator. After the impurities on the surface of the separator was cleaned with DMC, the separator was dried at 60° C. to obtain a test sample of the separator. A small disc with an area of S mm² was punched on the test sample of the separator, the mass of the small disc was weighed and recorded as m₃. Then, a second adhesive coating on the small disc was peeled off to obtain a mass of the small disc after the second adhesive coating was peeled off, where the mass was recorded as m₄. A single-side coating weight of the second adhesive coating was equal to (m₃−m₄)/S.

### Test of Thickness of First Adhesive Coating and Thickness of Second Adhesive Coating:

Argon ion polishing was performed on the coated separator to obtain a cross-section of the separator. The cross-section was observed using a scanning electron microscopy. A thickness of the first adhesive coating and a thickness of the second adhesive coating were measured. In the cross-section of the separator, a side with particles having relatively smaller diameters was a first adhesive coating containing a first polymer binder. A side with particles having relatively larger diameters was a second adhesive coating containing a second polymer binder.

### Test of Coverage Rate of First Polymer Binder:

A surface of a side of a separator where a first adhesive coating was provided was observed using a scanning electron microscopy (SEM), and a coverage rate was obtained according to a ratio of a region area occupied by a first polymer binder in an electron microscope image to an entire sampled separator region area in the electron microscope image.

### Test of Coverage Rate of Second Polymer Binder:

A surface of a side of a separator where the second adhesive coating was provided was observed using SEM, and a coverage rate was obtained by a ratio of a region area occupied by a second polymer binder in an electron microscope image to an entire sampled separator region area in the electron microscope image.

### Test of Adhesion Force F₁ of Separator to Positive Electrode Sheet:

An adhesion force between a separator and a positive electrode sheet was tested using a 180° peel test. After discharged at 0.5C to 3.0 V, a lithium-ion battery in each of examples and comparative examples under test was disassembled to peel off a negative electrode sheet. The separator and the positive electrode sheet were soaked in dimethyl carbonate for 20 min to remove an electrolyte. Then, the separator and the positive electrode sheet were cut into samples with specifications of 54.2 mm×72.5 mm. The separator and the positive electrode sheet were compounded and hot pressed using a hot press for 85 s at 85° C. and 1 MPa. The compounded sample was cut into strips with specifications of 15 mm×54.2 mm to obtain test strips for testing an adhesion force of the separator to the positive electrode sheet. A 15 mm×55 mm double-sided tape (NITTO.NO5000NS) was pasted on a steel plate. Then, a test strip was pasted on the double-sided tape with a test surface facing down. A 15 mm×70 mm paper tape was connected to one end of the test strip through the double-sided tape. A 2 kg small stick was pushed by hands to roll on the test strip by hand 8 times to obtain a test sample. A tensile machine was used for testing. The test sample was fixed on a test bench. The paper tape was folded upwards by 180° and fixed with a clamp. Then, the tensile machine started to pull the paper tape at a speed of 50 mm/min until the separator and the positive electrode sheet on the surface of the double-sided tape were separated, and the test ended. The test data were saved. The adhesion force F₁ between the separator and the positive electrode sheet was calculated according to a pulling force and a tensile displacement when the separator and the positive electrode sheet were separated, in N/m.

### Test of Adhesion Force F₂ of Separator to Negative Electrode Sheet:

An adhesion force between a separator and a negative electrode sheet was tested using a 180° peel test. After discharged at 0.5C to 3.0 V, a lithium-ion battery in each of examples and comparative examples under test was disassembled to peel off a positive electrode sheet. The separator and the negative electrode sheet were soaked in dimethyl carbonate for 20 min to remove an electrolyte. Then, the separator and the negative electrode sheet were cut into samples with specifications of 54.2 mm×72.5 mm. The separator and the negative electrode sheet were compounded and hot pressed using a hot press for 85 s at 85° C. and 1 MPa. The compounded sample was cut into strips with specifications of 15 mm×54.2 mm to obtain test strips for testing an adhesion force of the separator to the negative electrode sheet. Then, the adhesion force F₂ between the separator and the negative electrode sheet was calculated according to the above process of testing the adhesion force between the separator and the positive electrode sheet, in N/m.

### Test of Cycling Performance:

The cycling performance of a lithium-ion battery was evaluated based on a capacity retention rate. A higher capacity retention rate indicated better cycling performance. A charging process of a lithium-ion battery in each of examples and comparative examples was divided into three stages for step charging. Charging was performed under charging rates of 10C/8C/6C in sequence to carry out the test of the cycling performance. The specific test steps were as follows: the test temperature was adjusted to a constant temperature of 25° C. Then, the test was started and performed in the following steps: (1) the lithium-ion battery was charged at a constant current of 10C to 4.2 V; (2) the lithium-ion battery was charged at a constant current of 8C to 4.3 V; (3) the lithium-ion battery was charged at a constant current of 6C to 4.45 V; (4) the lithium-ion battery was charged at a constant voltage of 4.45 V to 0.05C; (5) the lithium-ion battery was left standing for 5 min; (6) the lithium-ion battery was discharged at a constant current of 1C to 3.0 V; (7) the lithium-ion battery was left standing for 5 min; and (8) steps (1) to (7) were repeated for 1000 cycles (cls). Then, the test ended, and a first-cycle discharge capacity and a discharge capacity after 1000 cls of the lithium-ion battery were recorded. Capacity retention rate (%)=discharge capacity after 1000 cls/first-cycle discharge capacity×100%.

### Test of High-Temperature Storage Performance:

The high-temperature storage performance of a lithium-ion battery was evaluated based on a swelling rate of the lithium-ion battery. A smaller swelling rate indicated better high-temperature storage performance. A thickness of the lithium-ion battery in a state after the preparation of the lithium-ion battery was completed, referred to as an initial thickness of the lithium-ion battery, was tested. The lithium-ion battery was fully charged in the following steps: the lithium-ion battery was charged at a constant current of 0.7C to 4.45 V and then charged at a constant voltage of 4.45 V to 0.02C; and then, a thickness of the lithium-ion battery in a fully charged state was tested. After the lithium-ion battery was stored in an environment at 80° C. for 8 h, a thickness of the lithium-ion battery after storage was tested. Then, the test ended. Swelling rate of lithium-ion battery=(thickness of lithium-ion battery after high-temperature storage−initial thickness of lithium-ion battery)/initial thickness of lithium-ion battery×100%.

### Example 1-1

### <Preparation of Separator>

Ceramic particles aluminum oxide, a ceramic coating binder butadiene-styrene polymer (at a mass ratio of butadiene to styrene of 2:1 and a weight-average molecular weight Mw=8×10⁶), and a solvent deionized water were mixed at a mass ratio of 35:10:55. Specifically, a total of 30 kg of butadiene-styrene polymer and deionized water were first added to a 60 L twin planetary mixer, and dispersed at 45° C. for 3 hours; then, 16.1 kg of aluminum oxide ceramic particles were added to the mixer and dispersed at a high speed at 45° C. for 2 hours; and then, a nano grinder was used to perform ball milling for 1.5 hours, with spherical zirconia beads with a diameter of 6 μm as a grinding medium, to obtain a ceramic coating slurry. An average particle size of the ceramic particles was 2 μm.

A first polymer binder polyacrylic acid (Mw=6000), a thickener sodium carboxymethyl cellulose, and a wetting agent polyoxyethylene ether (Mw=8000) were mixed at a mass ratio of 91:2:7, and deionized water was added as a solvent. The resulting mixture was stirred well to form a first adhesive coating slurry with a solid content of 75 wt %. An average particle size of the first polymer binder was 1.6 μm. The first polymer binder was of a non-core-shell structure.

A second polymer binder polyvinylidene fluoride (Mw=850000) and an auxiliary binder methacrylic acid were mixed at a mass ratio of 93:7, and deionized water was added as a solvent. The resulting mixture was stirred well to form a second adhesive coating slurry with a solid content of 75 wt %. An average particle size of the second polymer binder was 25 μm. The second polymer binder was of a non-core-shell structure.

A single-layer polypropylene film with a thickness of 5 μm was used as a separator substrate. The ceramic coating slurry was applied on one surface of the separator substrate and dried at 60° C., and then a ceramic coating was formed on one surface of the separator substrate. The second adhesive coating slurry was applied on a surface of the ceramic coating away from the separator substrate and dried at 60° C., and then a second adhesive coating was formed on the surface of the ceramic coating away from the separator substrate. The first adhesive coating slurry was applied on another surface of the separator substrate and dried at 60° C., and then a first adhesive coating was formed on the another surface of the separator substrate to obtain a separator (with a structure referred to FIG. 4, but not limited to FIG. 4).

A single-side coating weight Cw₁ of the first adhesive coating was 0.0006 mg/mm². A thickness H₁ of the first adhesive coating was 2 μm. A single-side coating weight Cw₂ of the second adhesive coating was 0.0012 mg/mm². A thickness H₂ of the second adhesive coating was 12 μm. A single-side coating weight Cw₃ of the ceramic coating was 0.06 mg/mm². A thickness of the ceramic coating H₃ was 1 μm. A coverage rate Cr₁ of the first polymer binder in the first adhesive coating per unit area was 50%. A coverage rate Cr₂ of the second polymer binder in the second adhesive coating per unit area was 50%.

### <Preparation of Positive Electrode Sheet>

A positive electrode active material lithium cobalt oxide, a positive electrode conductive agent carbon fiber, and a positive electrode binder polyvinylidene fluoride (PVDF, Mw=7×10⁶) were mixed at a mass ratio of 95:2.5:2.5, and N-methylpyrrolidone (NMP) was added as a solvent. The resulting mixture was stirred under the action of a vacuum mixer to obtain a positive electrode slurry with a solid content of 75 wt % and a uniform system. The positive electrode slurry was uniformly applied on one surface of a positive electrode current collector aluminum foil with a thickness of 13 μm, followed by drying at 95° C. to obtain a positive electrode sheet having one surface coated with a positive electrode active material layer. Then, the above steps were repeated on another surface of the aluminum foil to obtain a positive electrode sheet having two surfaces coated with positive electrode active material layers. Then, cold pressing, cutting, and slitting were performed. Drying was performed at 85° C. for 4 h under vacuum after slitting to obtain a positive electrode sheet with specifications of 60 mm×1580 mm for later use. A single-layer thickness of the positive electrode active material layer was 38.5 μm, and a thickness of the positive electrode sheet was 90 μm. 18 positive electrode tabs were integrally formed in a tab region of the positive electrode current collector by die cutting. A coating weight W_{z} of the positive electrode active material layer was 9.08 mg/cm².

### <Preparation of Negative Electrode Sheet>

A negative electrode active material artificial graphite, a negative electrode conductive agent Super P, a stabilizer sodium carboxymethyl cellulose (CMC-Na, Mw=7×10⁵), and a negative electrode binder styrene-butadiene rubber (SBR, Mw=6×10⁶) were mixed at a mass ratio of 96.5:1.0:1.0:1.5, then deionized water was added as a solvent. The resulting mixture was stirred under the action of a vacuum mixer to obtain a negative electrode slurry with a solid content of 51 wt % and a uniform system. The negative electrode slurry was uniformly applied on one surface of a negative electrode current collector copper foil with a thickness of 10 μm, followed by drying at 85° C. to obtain a negative electrode sheet having one surface coated with a negative electrode active material layer. Then, the above steps were repeated on another surface of the copper foil to obtain a negative electrode sheet having two surfaces coated with negative electrode active material layers. Then, cold pressing, cutting, and slitting were performed. Drying was performed at 110° C. for 4 h under vacuum after slitting to obtain a negative electrode sheet with specifications of 62 mm×1600 mm for later use. A single-layer thickness of the negative electrode active material layer was 58.5 μm, and a thickness of the negative electrode sheet was 127 μm. 18 negative electrode tabs were integrally formed in a tab region of the negative electrode current collector by die cutting. A coating weight W_{f} of the negative electrode active material layer was 4.54 mg/cm².

### <Preparation of Electrolyte>

In an environment with a water content of less than 10 ppm, a chain carboxylate n-propyl propionate and a non-chain carboxylate including ethylene carbonate and diethyl carbonate were mixed to obtain an organic solvent. Then, a lithium salt lithium hexafluorophosphate (LiPF₆) and an additive succinonitrile were added, dissolved, and mixed well to obtain an electrolyte. Based on a mass of the electrolyte, a mass percentage of the chain carboxylate n-propyl propionate was 30%, a mass percentage of the lithium salt LiPF₆ was 15%, a mass percentage of the additive was 7%, and the rest was the non-chain carboxylate including ethylene carbonate and diethyl carbonate at a mass ratio of 1:1.

### <Preparation of Lithium-Ion Battery>

The separator, the positive electrode sheet, the separator, and the negative electrode sheet were stacked in sequence, so that the separator was located between the positive electrode sheet and the negative electrode sheet for isolation, the first adhesive coating in the separator was close to the negative electrode sheet, and the second adhesive coating was close to the positive electrode sheet. Then, the resulting stack was wound to obtain an electrode assembly. The electrode assembly was placed in an aluminum-plastic film housing, and electrolyte injection was performed after drying. Then, processes such as vacuum packaging, standing, formation, capacity testing, degassing, and trimming were performed to obtain a lithium-ion battery.

### Examples 1-2 to 1-16

These examples were the same as Example 1-1 except that the relevant parameters were adjusted according to Table 1. When the mass percentage of the chain carboxylate changed, the mass percentage of the non-chain carboxylate changed accordingly, and the mass percentages of the lithium salt and the additive remained unchanged.

### Example 1-17

This example was the same as Example 1-1 except for the following process in <preparation of lithium-ion battery>.

### <Preparation of Lithium-Ion Battery>

The separator, the positive electrode sheet, the separator, and the negative electrode sheet were stacked in sequence, so that the separator was located between the positive electrode sheet and the negative electrode sheet for isolation, the first adhesive coating in the separator was close to the positive electrode sheet, and the second adhesive coating was close to the negative electrode sheet. Then, the resulting stack was wound to obtain an electrode assembly. The electrode assembly was placed in an aluminum-plastic film housing, and electrolyte injection was performed after drying. Then, processes such as vacuum packaging, standing, formation, capacity testing, degassing, and trimming were performed to obtain a lithium-ion battery.

### Examples 2-1 to 2-6

These examples were the same as Example 1-1 except that the mass percentages of the organic solvent, the lithium salt, and the additive were adjusted according to Table 2, the mass percentage of the chain carboxylate remained unchanged, and the mass percentage of the non-chain carboxylate changed accordingly.

### Examples 2-7 to 2-9

These examples were the same as Example 1-1 except that the type of the chain carboxylate was adjusted according to Table 2.

### Examples 2-10 and 2-11

These examples were the same as Example 1-1 except that the type of the non-chain carboxylate was adjusted according to Table 2.

### Example 2-12

This example was the same as Example 1-1 except that the type of the lithium salt was adjusted according to Table 2.

### Example 2-13

This example was the same as Example 1-1 except that the type of the additive was adjusted according to Table 2.

### Examples 3-1 to 3-12

These examples were the same as Example 1-1 except that the relevant parameters were adjusted according to Table 3.

### Comparative Example 1

This comparative example was the same as Example 1-1 except that the separator was prepared in the following process in <preparation of separator>, and W_{f} and W_{z} were adjusted according to Table 1, no chain carboxylate was added to the electrolyte, the mass percentage of the non-chain carboxylate changed accordingly, and the mass percentages of the lithium salt and the additive remained unchanged.

### <Preparation of Separator>

A single-layer polypropylene film with a thickness of 5 μm was used as a separator substrate. Ceramic particles aluminum oxide, a ceramic coating binder butadiene-styrene polymer (at a mass ratio of butadiene to styrene of 2:1 and a weight-average molecular weight Mw=8×10⁶), and a solvent deionized water were mixed at a mass ratio of 35:10:55. Specifically, a total of 30 kg of butadiene-styrene polymer and deionized water were first added to a 60 L twin planetary mixer and dispersed at 45° C. for 3 hours; then, 16.1 kg of aluminum oxide ceramic particles were added to the mixer and dispersed at a high speed at 45° C. for 2 hours; and then, a nano grinder was used to perform ball milling for 1.5 hours, with spherical zirconia beads with a diameter of 6 μm as a grinding medium, to obtain a ceramic coating slurry. An average particle size of the ceramic particles was 2 μm. The ceramic coating slurry was applied on one surface of the separator substrate and dried at 60° C., and then a ceramic coating was formed on one surface of the separator substrate to obtain a separator.

### Comparative Examples 2 to 11

These comparative examples were the same as Example 1-1 except that W_{f}, W_{z}, the average particle size of the first polymer binder, the average particle size of the second polymer binder, and the mass percentage of the chain carboxylate in the electrolyte were adjusted according to Table 1, the mass percentage of the non-chain carboxylate changed accordingly, and the mass percentages of the lithium salt and the additive remained unchanged.

### Comparative Example 12

This comparative example was the same as Example 1-1 except for the following processes in <preparation of separator> and <preparation of lithium-ion battery>.

### <Preparation of Separator>

Preparation methods of a ceramic coating slurry and a first adhesive coating slurry as well as a separator substrate were the same as those in Example 1-1. The ceramic coating slurry was applied on one surface of the separator substrate and dried at 60° C., and then a ceramic coating was formed on one surface of the separator substrate. The first adhesive coating slurry was applied on a surface of the ceramic coating away from the separator substrate and dried at 60° C., and then a first adhesive coating was formed on the surface of the ceramic coating away from the separator substrate. The first adhesive coating slurry was applied on another surface of the separator substrate and dried at 60° C., and then the first adhesive coating was formed on the another surface of the separator substrate to obtain a separator.

### <Preparation of Lithium-Ion Battery>

The preparation of the lithium-ion battery was the same as that in Example 1-1 except that the surface of the separator where the ceramic coating was provided was closer to the positive electrode sheet.

### Comparative Example 13

This comparative example was the same as Comparative Example 12 except for the following process in <preparation of separator>.

### <Preparation of Separator>

A ceramic coating slurry was applied on one surface of a separator substrate and dried at 60° C., and then a ceramic coating was formed on one surface of the separator substrate. A second adhesive coating slurry was applied on a surface of the ceramic coating away from the separator substrate and dried at 60° C., and then a second adhesive coating was formed on the surface of the ceramic coating away from the separator substrate. The second adhesive coating slurry was applied on another surface of the separator substrate and dried at 60° C., and then the second adhesive coating was formed on the another surface of the separator substrate to obtain a separator.

### Comparative Example 14

This comparative example was the same as Comparative Example 12 except that W_{f} and W_{z} were adjusted according to Table 1, the mass percentage of the chain carboxylate and the mass percentage of the non-chain carboxylate changed accordingly, and the mass percentages of the lithium salt and the additive remained unchanged.

### Comparative Example 15

This comparative example was the same as Comparative Example 13 except that W_{f} and W_{z} were adjusted according to Table 1, the mass percentage of the chain carboxylate and the mass percentage of the non-chain carboxylate changed accordingly, and the mass percentages of the lithium salt and the additive remained unchanged.

The preparation parameters and performance parameters of examples and comparative examples were shown in Tables 1 to 3.

TABLE 1

| | | | | Average | Average | | | | | |
|---|---|---|---|---|---|---|---|---|---|---|
| | | | | particle | particle | | | | | |
| | | | | size of | size of | Mass | | | | |
| | | | | first | second | percentage | | | | |
| | | | | polymer | polymer | of chain | | | Capacity | |
| | W_{f} | | W_{z} | binder | binder | carboxylate | F₁ | F₂ | retention | Swelling |
| | (mg/cm²) | W_{z}/W_{f} | (mg/cm²) | (μm) | (μm) | (%) | (N/m) | (N/m) | rate (%) | rate (%) |
| Example 1-1 | 4.54 | 2 | 9.08 | 1.6 | 25 | 30 | 8.4 | 12.5 | 84.9 | 8.2 |
| Example 1-2 | 3.25 | 2 | 6.5 | 1.6 | 25 | 30 | 8.5 | 12.2 | 86.6 | 8.8 |
| Example 1-3 | 5.84 | 2 | 11.68 | 1.6 | 25 | 30 | 8.2 | 12.1 | 82.2 | 8.6 |
| Example 1-4 | 4.54 | 1.6 | 7.26 | 1.6 | 25 | 30 | 8.7 | 12.4 | 77.6 | 9.2 |
| Example 1-5 | 4.54 | 2.2 | 9.99 | 1.6 | 25 | 30 | 8.3 | 12.3 | 76.2 | 7.7 |
| Example 1-6 | 3.25 | 1.6 | 5.2 | 1.6 | 25 | 30 | 8.5 | 12.2 | 71.6 | 11.3 |
| Example 1-7 | 5.84 | 2.2 | 12.85 | 1.6 | 25 | 30 | 8.1 | 12.3 | 70.2 | 7.5 |
| Example 1-8 | 4.54 | 2 | 9.08 | 0.3 | 25 | 30 | 8.4 | 9.2 | 85.2 | 13.5 |
| Example 1-9 | 4.54 | 2 | 9.08 | 3 | 25 | 30 | 8.2 | 14.3 | 80.6 | 7.2 |
| Example 1-10 | 4.54 | 2 | 9.08 | 1.6 | 10 | 30 | 6.6 | 12.1 | 80.0 | 14.6 |
| Example 1-11 | 4.54 | 2 | 9.08 | 1.6 | 38 | 30 | 11.0 | 12.4 | 84.3 | 7.4 |
| Example 1-12 | 4.54 | 2 | 9.08 | 1.6 | 25 | 6 | 8.2 | 12.3 | 70.4 | 5.9 |
| Example 1-13 | 4.54 | 2 | 9.08 | 1.6 | 25 | 18 | 8.2 | 12.2 | 80.2 | 6.7 |
| Example 1-14 | 4.54 | 2 | 9.08 | 1.6 | 25 | 24 | 8.3 | 12.5 | 82.1 | 7.5 |
| Example 1-15 | 4.54 | 2 | 9.08 | 1.6 | 25 | 40 | 8.1 | 12.3 | 85.7 | 9.2 |
| Example 1-16 | 4.54 | 2 | 9.08 | 1.6 | 25 | 56 | 8.4 | 12.2 | 80.9 | 16.7 |
| Example 1-17 | 4.54 | 2 | 9.08 | 1.6 | 25 | 30 | 12.3 | 4.1 | 75.1 | 16.2 |
| Comparative | 6.5 | 2 | 13 | / | / | / | 0 | 0 | 33.4 | 32.6 |
| Example 1 | | | | | | | | | | |
| Comparative | 2.5 | 2 | 5 | 1.6 | 25 | 30 | 8.3 | 12.3 | 82.6 | 8.6 |
| Example 2 | | | | | | | | | | |
| Comparative | 6.5 | 2 | 13 | 1.6 | 25 | 30 | 8.2 | 12.2 | 64.3 | 8.3 |
| Example 3 | | | | | | | | | | |
| Comparative | 4.54 | 1 | 4.54 | 1.6 | 25 | 30 | 8.5 | 12.3 | 35.3 | 10.7 |
| Example 4 | | | | | | | | | | |
| Comparative | 4.54 | 3 | 13.62 | 1.6 | 25 | 30 | 8.3 | 12.5 | 45.3 | 8.2 |
| Example 5 | | | | | | | | | | |
| Comparative | 4.54 | 2 | 9.08 | 0.1 | 25 | 30 | 8.5 | 3.2 | 69.4 | 25.5 |
| Example 6 | | | | | | | | | | |
| Comparative | 4.54 | 2 | 9.08 | 4 | 25 | 30 | 8.3 | 14.3 | 65.4 | 8.1 |
| Example 7 | | | | | | | | | | |
| Comparative | 4.54 | 2 | 9.08 | 1.6 | 5 | 30 | 1.2 | 12.1 | 63.2 | 18.7 |
| Example 8 | | | | | | | | | | |
| Comparative | 4.54 | 2 | 9.08 | 1.6 | 43 | 30 | 11.3 | 12.4 | 54.3 | 8.0 |
| Example 9 | | | | | | | | | | |
| Comparative | 4.54 | 2 | 9.08 | 1.6 | 25 | 3 | 8.5 | 12.0 | 42.4 | 7.1 |
| Example 10 | | | | | | | | | | |
| Comparative | 4.54 | 2 | 9.08 | 1.6 | 25 | 63 | 8.2 | 12.3 | 65.4 | 45.3 |
| Example 11 | | | | | | | | | | |
| Comparative | 4.54 | 2 | 9.08 | 1.6 | / | 30 | 12.3 | 12.2 | 60.1 | 7.1 |
| Example 12 | | | | | | | | | | |
| Comparative | 4.54 | 2 | 9.08 | / | 25 | 30 | 8.1 | 1.5 | 80.2 | 25.2 |
| Example 13 | | | | | | | | | | |
| Comparative | 6.5 | 2 | 13 | 1.6 | / | 3 | 12.3 | 12.3 | 43.2 | 8.1 |
| Example 14 | | | | | | | | | | |
| Comparative | 6.5 | 2 | 13 | / | 25 | 3 | 8.4 | 1.2 | 62.1 | 19.8 |
| Example 15 | | | | | | | | | | |

Note:
“/” in Table 1 indicates no relevant parameters.

From Examples 1-1 to 1-14 and Comparative Examples 1 to 8, it can be seen that in this application, the values of W_{f} and W_{z} are adjusted within the ranges of this application, the first adhesive coating and the second adhesive coating are respectively provided on two sides of the separator, the average particle size of the first polymer binder in the first adhesive coating and the average particle size of the second polymer binder in the second adhesive coating are within the ranges of this application, and the chain carboxylate is added to the electrolyte, and the mass percentage of the chain carboxylate is adjusted within the range of this application, so that the adhesion force of the separator to the positive electrode sheet or the negative electrode sheet is high, and the lithium-ion battery has a higher capacity retention rate under fast charging conditions and a lower swelling rate after storage at 80° C. for 8 h. This indicates that the lithium-ion battery in this application has better cycling performance and high-temperature storage performance under fast charging conditions. For the lithium-ion battery in Comparative Example 1, the values of W_{f} and W_{z} are not within the ranges of this application, no first adhesive coating or no second adhesive coating is provided on two sides of the separator, and no chain carboxylate is added to the electrolyte. For the lithium-ion battery in each of Comparative Examples 2 and 3, W_{f} is not within the range of this application. For the lithium-ion battery in each of Comparative Examples 4 and 5, W_{z} is not within the range of this application. For the lithium-ion battery in each of Comparative Examples 6 and 7, the average particle size of the first polymer binder in the separator is not within the range of this application. For the lithium-ion battery in each of Comparative Examples 8 and 9, the average particle size of the second polymer binder in the separator is not within the range of this application. For the lithium-ion battery in each of Comparative Examples 10 and 11, the mass percentage of the chain carboxylate is not within the range of this application. For the lithium-ion battery of Comparative Example 12, the separator is provided with the first adhesive coating on each of two sides, which is not the separator structure of this application. For the lithium-ion battery of Comparative Example 13, the separator is provided with the second adhesive coating on each of two sides, which is not the separator structure of this application. For the lithium-ion battery of Comparative Example 14, the separator is provided with the first adhesive coating on each of two sides, and the values of W_{f} and W_{z} and the mass percentage of the chain carboxylate are not within the ranges of this application. For the lithium-ion battery of Comparative Example 15, the separator is provided with the second adhesive coating on each of two sides, which is not the separator structure of this application; and the values of W_{f} and W_{z} and the mass percentage of the chain carboxylate are not within the ranges of this application. In the lithium-ion battery in each of Comparative Examples 1 to 15, the lithium-ion battery has a lower capacity retention rate under fast charging conditions and/or a higher swelling rate after storage at 80° C. for 8 h, indicating that the lithium-ion battery has worse cycling performance and/or high-temperature storage performance under fast charging conditions.

The value of W_{f} typically affects the cycling performance and high-temperature storage performance of the lithium-ion battery. From Examples 1-1 to 1-3 and Comparative Examples 2 and 3, it can be seen that the lithium-ion battery with the value of W_{f} within the range of this application has a high capacity retention rate under fast charging conditions and a low swelling rate after storage at 80° C. for 8 h, indicating that the lithium-ion battery has good cycling performance and high-temperature storage performance under fast charging conditions. In Comparative Example 2, the coating weight W_{z} of the positive electrode active material layer and the coating weight W_{f} of the negative electrode active material layer are relatively low. Although the obtained lithium-ion battery has a high capacity retention rate and a low swelling rate, due to the excessively low coating weights of the positive electrode active material layer and the negative electrode active material layer, the cost of precisely controlling the coating weight in actual industrial production is excessively high, the yield of lithium-ion batteries obtained in large-scale production is excessively low, and the energy density of the obtained lithium-ion batteries is excessively low, which cannot meet the needs of actual production and is not suitable for industrial production applications.

The value of W_{z}/W_{f} typically affects the cycling performance and high-temperature storage performance of the lithium-ion battery. From Example 1-1, Examples 1-4 and 1-5, and Comparative Examples 4 and 5, it can be seen that the lithium-ion battery with the value of W_{z}/W_{f} within the range of this application has a higher capacity retention rate under fast charging conditions and a lower swelling rate after storage at 80° C. for 8 h, indicating that the lithium-ion battery has better cycling performance and high-temperature storage performance under fast charging conditions.

The value of W_{z} typically affects the cycling performance and high-temperature storage performance of the lithium-ion battery. From Examples 1-1 to 1-7, it can be seen that the lithium-ion battery with the value of W_{z} within the range of this application has a high capacity retention rate under fast charging conditions and a low swelling rate after storage at 80° C. for 8 h, indicating that the lithium-ion battery has good cycling performance and high-temperature storage performance under fast charging conditions.

The average particle size of the first polymer binder typically affects the cycling performance and high-temperature storage performance of the lithium-ion battery. From Example 1-1, Examples 1-8 and 1-9, and Comparative Examples 6 and 7, it can be seen that the lithium-ion battery with the average particle size of the first polymer binder within the range of this application has a separator with a high adhesion force to the negative electrode sheet, a higher capacity retention rate under fast charging conditions, and a lower swelling rate after storage at 80° C. for 8 h, indicating that the lithium-ion battery has better cycling performance and high-temperature storage performance under fast charging conditions.

The average particle size of the second polymer binder typically affects the cycling performance and high-temperature storage performance of the lithium-ion battery. From Example 1-1, Examples 1-10 and 1-11, and Comparative Examples 8 and 9, it can be seen that the lithium-ion battery with the average particle size of particles of the first polymer binder within the range of this application has a separator with a high adhesion force to the positive electrode sheet, a higher capacity retention rate under fast charging conditions, and a lower swelling rate after storage at 80° C. for 8 h, indicating that the lithium-ion battery has better cycling performance and high-temperature storage performance under fast charging conditions.

The positional relationships between the first adhesive coating and the second adhesive coating in the separator and the positive electrode sheet and the negative electrode sheet typically affect the kinetic performance, cycling performance, and mechanical reliability of the secondary battery. From Example 1-1 and Example 1-17, it can be seen that the adhesion between the second polymer binder polyvinylidene fluoride and the negative electrode sheet is poor, resulting in a low adhesion force F₂ of the separator to the negative electrode sheet, thus causing the lithium-ion battery in Example 1-17 to be more prone to swelling and to exhibit relatively lower cycling performance than the lithium-ion battery in Example 1-1.

The mass percentage of the chain carboxylate typically affects the cycling performance and high-temperature storage performance of the lithium-ion battery. From Example 1-1, Examples 1-12 to 1-16, and Comparative Examples 10 and 11 where the mass percentage of the chain carboxylate in the lithium-ion battery is not within the range of this application, it can be seen that the lithium-ion battery with the mass percentage of the chain carboxylate within the range of this application has a higher capacity retention rate under fast charging conditions and a lower swelling rate after storage at 80° C. for 8 h, indicating that the lithium-ion battery has better cycling performance and high-temperature storage performance under fast charging conditions.

TABLE 2

| | | | Mass | Mass | | Mass | | | | |
|---|---|---|---|---|---|---|---|---|---|---|
| | | | percentage | percentage | | percentage | | Mass | | |
| | | | of | of | | of | | percentage | Capacity | |
| | Type of | Type of | non-chain | organic | Type of | lithium | | of | retention | Swelling |
| | chain | non-chain | carboxylate | solvent | lithium | salt | Type of | additive | rate | rate |
| | carboxylate | carboxylate | (%) | (%) | salt | (%) | additive | (%) | (%) | (%) |
| Example 1-1 | N-propyl | Ethylene | 48 | 78 | LiPF₆ | 15 | Succinonitrile | 7 | 84.9 | 8.2 |
| | propionate | carbonate + | | | | | | | | |
| | | diethyl carbonate | | | | | | | | |
| Example 2-1 | N-propyl | Ethylene | 40 | 70 | LiPF₆ | 20 | Succinonitrile | 10 | 84.1 | 8.0 |
| | propionate | carbonate + | | | | | | | | |
| | | diethyl carbonate | | | | | | | | |
| Example 2-2 | N-propyl | Ethylene | 50 | 80 | LiPF₆ | 10 | Succinonitrile | 10 | 82.1 | 9.1 |
| | propionate | carbonate + | | | | | | | | |
| | | diethyl carbonate | | | | | | | | |
| Example 2-3 | N-propyl | Ethylene | 50 | 80 | LiPF₆ | 15 | Succinonitrile | 5 | 83.2 | 8.8 |
| | propionate | carbonate + | | | | | | | | |
| | | diethyl carbonate | | | | | | | | |
| Example 2-4 | N-propyl | Ethylene | 48 | 78 | LiPF₆ | 20 | Succinonitrile | 2 | 82.1 | 9.2 |
| | propionate | carbonate + | | | | | | | | |
| | | diethyl carbonate | | | | | | | | |
| Example 2-5 | N-propyl | Ethylene | 55 | 85 | LiPF₆ | 15 | / | / | 75.6 | 12.8 |
| | propionate | carbonate + | | | | | | | | |
| | | diethyl carbonate | | | | | | | | |
| Example 2-6 | N-propyl | Ethylene | 35 | 65 | LiPF₆ | 20 | Succinonitrile | 15 | 73.4 | 8.2 |
| | propionate | carbonate + | | | | | | | | |
| | | diethyl carbonate | | | | | | | | |
| Example 2-7 | N-butyl | Ethylene | 48 | 78 | LiPF₆ | 15 | Succinonitrile | 7 | 83.5 | 8.3 |
| | butyrate | carbonate + | | | | | | | | |
| | | diethyl carbonate | | | | | | | | |
| Example 2-8 | Methyl | Ethylene | 48 | 78 | LiPF₆ | 15 | Succinonitrile | 7 | 84.2 | 8.4 |
| | formate | carbonate + | | | | | | | | |
| | | diethyl carbonate | | | | | | | | |
| Example 2-9 | Ethyl | Ethylene | 48 | 78 | LiPF₆ | 15 | Succinonitrile | 7 | 83.6 | 8.4 |
| | butyrate | carbonate + | | | | | | | | |
| | | diethyl carbonate | | | | | | | | |
| Example 2-10 | N-propyl | Ethylene | 48 | 78 | LiPF₆ | 15 | Succinonitrile | 7 | 83.8 | 8.5 |
| | propionate | carbonate + | | | | | | | | |
| | | methyl ethyl | | | | | | | | |
| | | carbonate | | | | | | | | |
| Example 2-11 | N-propyl | γ- | 48 | 78 | LiPF₆ | 15 | Succinonitrile | 7 | 82.3 | 8.3 |
| | propionate | butyrolactone + | | | | | | | | |
| | | diethyl carbonate | | | | | | | | |
| Example 2-12 | N-propyl | Ethylene | 48 | 78 | LiBF₄ | 15 | Succinonitrile | 7 | 84.2 | 8.4 |
| | propionate | carbonate + | | | | | | | | |
| | | diethyl carbonate | | | | | | | | |
| Example 2-13 | N-propyl | Ethylene | 48 | 78 | LiPF₆ | 15 | 1,2-bis(2- | 7 | 81.1 | 8.4 |
| | propionate | carbonate + | | | | | cyanoethoxy) | | | |
| | | diethyl carbonate | | | | | ethane | | | |

Note:
“/” in Table 2 indicates no relevant parameters or substances. In Table 2, the mass ratio of the two solvents of the non-chain carboxylate is 1:1.

The mass percentages of the organic solvent, the lithium salt, and the additive typically affect the cycling performance and high-temperature storage performance of the lithium-ion battery. From Examples 1-1 and 2-1 to 2-6, it can be seen that the lithium-ion battery with the mass percentages of the organic solvent, lithium salt, and additive in the electrolyte within the ranges of this application has a high capacity retention rate under fast charging conditions and a low swelling rate after storage at 80° C. for 8 h, indicating that the lithium-ion battery has good cycling performance and high-temperature storage performance under fast charging conditions.

The type of the chain carboxylate typically affects the cycling performance and high-temperature storage performance of the lithium-ion battery. From Examples 1-1 and 2-7 to 2-9, it can be seen that the lithium-ion battery using the type of the chain carboxylate within the range of this application has a high capacity retention rate under fast charging conditions and a low swelling rate after storage at 80° C. for 8 h, indicating that the lithium-ion battery has good cycling performance and high-temperature storage performance under fast charging conditions.

The type of the non-chain carboxylate typically affects the cycling performance and high-temperature storage performance of the lithium-ion battery. From Examples 1-1, 2-10, and 2-11, it can be seen that the lithium-ion battery using the type of the non-chain carboxylate within the range of this application has a high capacity retention rate under fast charging conditions and a low swelling rate after storage at 80° C. for 8 h, indicating that the lithium-ion battery has good cycling performance and high-temperature storage performance under fast charging conditions.

The type of the lithium salt typically affects the cycling performance and high-temperature storage performance of the lithium-ion battery. From Example 1-1 and Example 2-12, it can be seen that the lithium-ion battery using the type of the lithium salt within the range of this application has a high capacity retention rate under fast charging conditions and a low swelling rate after storage at 80° C. for 8 h, indicating that the lithium-ion battery has good cycling performance and high-temperature storage performance under fast charging conditions.

The type of the additive typically affects the cycling performance and high-temperature storage performance of the lithium-ion battery. From Example 1-1 and Example 2-13, it can be seen that the lithium-ion battery using the type of the additive within the range of this application has a high capacity retention rate under fast charging conditions and a low swelling rate after storage at 80° C. for 8 h, indicating that the lithium-ion battery has good cycling performance and high-temperature storage performance under fast charging conditions.

TABLE 3

| | | | | | Cw₁ | Cw₂ | | | | | Capacity | |
|---|---|---|---|---|---|---|---|---|---|---|---|---|
| | First polymer | Second polymer | Cr₁ | Cr₂ | (mg/ | (mg/ | H₁ | H₂ | F₁ | F₂ | retention | Swelling |
| | binder | binder | (%) | (%) | mm²) | mm²) | (μm) | (μm) | (N/m) | (N/m) | rate (%) | rate (%) |
| Example 1-1 | Polyacrylic acid | Polyvinylidene | 50 | 50 | 0.0006 | 0.0012 | 2 | 12 | 8.4 | 12.5 | 84.9 | 8.2 |
| | | fluoride | | | | | | | | | | |
| Example 3-1 | Polyacrylic acid | Polyvinylidene | 40 | 50 | 0.0001 | 0.0012 | 0.2 | 12 | 8.2 | 9.6 | 83.3 | 8.8 |
| | | fluoride | | | | | | | | | | |
| Example 3-2 | Polyacrylic acid | Polyvinylidene | 60 | 50 | 0.001 | 0.0012 | 4.0 | 12 | 8.2 | 14.4 | 82.5 | 8.1 |
| | | fluoride | | | | | | | | | | |
| Example 3-3 | Polyacrylic acid | Polyvinylidene | 10 | 50 | 0.00005 | 0.0012 | 0.15 | 12 | 8.3 | 8.4 | 76.6 | 12.2 |
| | | fluoride | | | | | | | | | | |
| Example 3-4 | Polyacrylic acid | Polyvinylidene | 80 | 50 | 0.0016 | 0.0012 | 6.8 | 12 | 8.1 | 15.6 | 73.2 | 8.0 |
| | | fluoride | | | | | | | | | | |
| Example 3-5 | Polyacrylic acid | Polyvinylidene | 50 | 40 | 0.0006 | 0.0004 | 2 | 5 | 6.4 | 12.3 | 82.1 | 9.3 |
| | | fluoride | | | | | | | | | | |
| Example 3-6 | Polyacrylic acid | Polyvinylidene | 50 | 60 | 0.0006 | 0.002 | 2 | 20 | 9.6 | 12.4 | 81.2 | 8.0 |
| | | fluoride | | | | | | | | | | |
| Example 3-7 | Polyacrylic acid | Polyvinylidene | 50 | 16 | 0.0006 | 0.00035 | 2 | 3.1 | 5.6 | 12.4 | 78.3 | 13.4 |
| | | fluoride | | | | | | | | | | |
| Example 3-8 | Polyacrylic acid | Polyvinylidene | 50 | 75 | 0.0006 | 0.0028 | 2 | 26 | 10.4 | 12.5 | 72.5 | 7.8 |
| | | fluoride | | | | | | | | | | |
| Example 3-9 | Polyacrylonitrile | Polyvinylidene | 50 | 50 | 0.0006 | 0.0012 | 2 | 12 | 8.4 | 12.4 | 84.2 | 8.7 |
| | (Mw = 150000) | fluoride | | | | | | | | | | |
| Example 3-10 | Core: polyethyl | Polyvinylidene | 50 | 50 | 0.0006 | 0.0012 | 2 | 12 | 8.3 | 13.1 | 85.1 | 8.0 |
| | acrylate (Mw = | fluoride | | | | | | | | | | |
| | 95000); shell: | | | | | | | | | | | |
| | polymethyl | | | | | | | | | | | |
| | acrylate (Mw = | | | | | | | | | | | |
| | 40000-60000); | | | | | | | | | | | |
| | core-shell mass | | | | | | | | | | | |
| | ratio of 1:1 | | | | | | | | | | | |
| Example 3-11 | Polyacrylic acid | Polyvinylidene | 50 | 50 | 0.0006 | 0.0012 | 2 | 12 | 8.6 | 12.9 | 83.8 | 7.6 |
| | | chloride (Mw = | | | | | | | | | | |
| | | 500000) | | | | | | | | | | |
| Example 3-12 | Polyacrylic acid | Core: | 50 | 50 | 0.0006 | 0.0012 | 2 | 12 | 8.3 | 12.1 | 83.9 | 8.5 |
| | | polystyrene | | | | | | | | | | |
| | | (Mw = | | | | | | | | | | |
| | | 250000); shell: | | | | | | | | | | |
| | | polymethyl | | | | | | | | | | |
| | | acrylate (Mw = | | | | | | | | | | |
| | | 50000); | | | | | | | | | | |
| | | core-shell | | | | | | | | | | |
| | | mass ratio of | | | | | | | | | | |
| | | 1:1 | | | | | | | | | | |

The coverage rate Cr₁ of the first polymer binder in the first adhesive coating per unit area, the single-side coating weight Cw₁ of the first adhesive coating, and the thickness H₁ of the first adhesive coating typically affect the cycling performance and high-temperature storage performance of the lithium-ion battery. From Examples 1-1 and 3-1 to 3-4, it can be seen that the lithium-ion battery with the values of Cr₁, Cw₁, and H₁ within the ranges of this application has a separator with a high adhesion force to the positive electrode sheet or the negative electrode sheet, a high capacity retention rate under fast charging conditions, and a low swelling rate after storage at 80° C. for 8 h, indicating that the lithium-ion battery has good cycling performance and high-temperature storage performance under fast charging conditions.

The coverage rate Cr₂ of the second polymer binder in the second adhesive coating per unit area, the single-side coating weight Cw₂ of the second adhesive coating, and the thickness H₂ of the second adhesive coating typically affect the cycling performance and high-temperature storage performance of the lithium-ion battery. From Examples 1-1 and 3-5 to 3-8, it can be seen that the lithium-ion battery with the values of Cr₂, Cw₂, and H₂ within the range of this application has a separator with a high adhesion force to the positive electrode sheet or the negative electrode sheet, a high capacity retention rate under fast charging conditions, and a low swelling rate after storage at 80° C. for 8 h, indicating that the lithium-ion battery has good cycling performance and high-temperature storage performance under fast charging conditions.

The type of the first polymer binder typically affects the cycling performance and high-temperature storage performance of the lithium-ion battery. From Examples 1-1, 3-9, and 3-10, it can be seen that the lithium-ion battery using the type of first polymer binder within the range of this application has a separator with a high adhesion force to the positive electrode sheet or the negative electrode sheet, a high capacity retention rate under fast charging conditions, and a low swelling rate after storage at 80° C. for 8 h, indicating that the lithium-ion battery has good cycling performance and high-temperature storage performance under fast charging conditions.

The type of the second polymer binder typically affects the cycling performance and high-temperature storage performance of the lithium-ion battery. From Examples 1-1, 3-11, and 3-12, it can be seen that the lithium-ion battery using the type of second polymer binder within the range of this application has a separator with a high adhesion force to the positive electrode sheet or the negative electrode sheet, a high capacity retention rate under fast charging conditions, and a low swelling rate after storage at 80° C. for 8 h, indicating that the lithium-ion battery has good cycling performance and high-temperature storage performance under fast charging conditions.

It should be noted that in this specification, relational terms such as “first” and “second” are used merely to distinguish one entity or operation from another entity or operation, and do not necessarily require or imply any such actual relationship or sequence between these entities or operations. Moreover, the terms “include”, “comprise”, or any other variant thereof are intended to cover non-exclusive inclusion, such that a process, method, or article that includes a series of elements includes not only those elements but also other elements not explicitly listed, or further includes elements inherent to such process, method, or article.

The various embodiments in this specification are described in a related manner, and identical or similar parts between the various embodiments can be referred to each other, with each embodiment focusing on differences from other embodiments.

The above descriptions are merely preferred embodiments of this application and are not intended to limit this application. Any modification, equivalent substitution, improvement, and the like made within the spirit and principle of this application shall fall within the protection scope of this application.

What is claimed is:

1. A secondary battery, comprising a positive electrode sheet, a negative electrode sheet, a separator, and an electrolyte; wherein the positive electrode sheet comprises a positive electrode active material layer, the negative electrode sheet comprises a negative electrode active material layer; a coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm²;
the separator comprises a separator substrate, a first adhesive coating, and a second adhesive coating; wherein the first adhesive coating and the second adhesive coating are respectively provided on two sides of the separator substrate;
the first adhesive coating comprises a first polymer binder, and an average particle size of the first polymer binder is 0.3 μm to 3 μm; and the second adhesive coating comprises a second polymer binder, and an average particle size of the second polymer binder is 10 μm to 38 μm;
the electrolyte comprises an organic solvent, a lithium salt, and an additive; wherein the organic solvent comprises chain carboxylate; and based on a mass of the electrolyte, a mass percentage of the chain carboxylate is 6% to 56%.

2. The secondary battery according to claim 1, wherein 6.49 mg/cm²≤W_{z}≤11.69 mg/cm².

3. The secondary battery according to claim 1, wherein the first adhesive coating is provided on a side of the separator substrate facing the negative electrode sheet, and the second adhesive coating is provided on a side of the separator substrate facing the positive electrode sheet.

4. The secondary battery according to claim 1, wherein the chain carboxylate comprises at least one of methyl formate, methyl acetate, ethyl formate, ethyl acetate, propyl acetate, ethyl propionate, methyl propionate, n-propyl propionate, isopropyl propionate, n-butyl propionate, isobutyl propionate, n-pentyl propionate, isopentyl propionate, ethyl n-butyrate, n-propyl n-butyrate, propyl isobutyrate, n-pentyl n-butyrate, n-pentyl isobutyrate, n-butyl n-butyrate, isobutyl isobutyrate, or n-pentyl n-valerate.

5. The secondary battery according to claim 1, wherein the organic solvent further comprises at least one of ethylene carbonate, propylene carbonate, dimethyl carbonate, diethyl carbonate, methyl ethyl carbonate, γ-butyrolactone, or tetrahydrofuran; and based on the mass of the electrolyte, a mass percentage of the organic solvent is 70% to 80%.

6. The secondary battery according to claim 1, wherein the lithium salt comprises at least one of lithium hexafluorophosphate, lithium difluorophosphate, lithium tetrafluoroborate, lithium hexafluoroarsenate, lithium perchlorate, lithium bis(fluorosulfonyl)imide, lithium bis(trifluoromethanesulfonyl)imide, lithium bis(oxalato)borate, or lithium difluoro(oxalato)borate; and based on the mass of the electrolyte, a mass percentage of the lithium salt is 10% to 20%.

7. The secondary battery according to claim 1, wherein the additive comprises at least one of succinonitrile, glutaronitrile, pimelonitrile, 1,2-bis(2-cyanoethoxy)ethane, 1,2-bis(2-cyanoethoxy)propane, or 1,2,3-tris(2-cyanoethoxy)propane; and based on the mass of the electrolyte, a mass percentage of the additive is 2% to 10%.

8. The secondary battery according to claim 1, wherein based on the mass of the electrolyte, the mass percentage of the chain carboxylate is 18% to 40%.

9. The secondary battery according to claim 1, wherein a thickness of the first adhesive coating is 0.2 μm to 4 μm, and a thickness of the second adhesive coating is 5 μm to 20 μm.

10. The secondary battery according to claim 1, wherein a single-side coating weight of the first adhesive coating is 0.0001 mg/mm² to 0.001 mg/mm², and a single-side coating weight of the second adhesive coating is 0.0004 mg/mm² to 0.002 mg/mm².

11. The secondary battery according to claim 1, wherein a coverage rate of the first polymer binder in the first adhesive coating per unit area is 40% to 60%.

12. The secondary battery according to claim 1, wherein the first polymer binder comprises a core-shell first polymer binder or a non-core-shell first polymer binder;
a polymerized monomer of a core of the core-shell first polymer binder comprises at least one of ethyl acrylate, butyl acrylate, ethyl methacrylate, styrene, chlorostyrene, fluorostyrene, methylstyrene, acrylic acid, methacrylic acid, or maleic acid; and a polymerized monomer of a shell of the core-shell first polymer binder comprises at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile; and
a polymerized monomer of the non-core-shell first polymer binder comprises at least one of acrylic acid, methyl acrylate, butyl acrylate, butadiene, styrene, acrylonitrile, ethylene, fluorostyrene, chlorostyrene, or propylene.

13. The secondary battery according to claim 1, wherein a coverage rate of the second polymer binder in the second adhesive coating per unit area is 40% to 60%.

14. The secondary battery according to claim 1, wherein a polymerized monomer of the second polymer binder comprises at least one of vinylidene chloride, vinylidene fluoride, hexafluoropropylene, ethylene, propylene, vinyl chloride, chloropropene, acrylic acid, methyl acrylate, butyl acrylate, ethyl acrylate, chlorostyrene, fluorostyrene, ethyl methacrylate, methyl methacrylate, butyl methacrylate, ethyl chloromethyl acrylate, styrene, butadiene, or acrylonitrile.

15. The secondary battery according to claim 1, wherein the second polymer binder comprises a core-shell second polymer binder or a non-core-shell second polymer binder;
a polymerized monomer of a shell of the core-shell second polymer binder comprises at least one of vinylidene chloride, vinylidene fluoride, hexafluoropropylene, styrene, butadiene, acrylonitrile, acrylic acid, methyl acrylate, or butyl acrylate; and a core of the core-shell second polymer binder comprises at least one of methyl acrylate, butyl acrylate, ethyl acrylate, ethyl methacrylate, methyl methacrylate, butyl methacrylate, or ethyl chloromethyl acrylate; and
a polymerized monomer of the non-core-shell second polymer binder comprises at least one of acrylic acid, methyl acrylate, butyl acrylate, butadiene, styrene, acrylonitrile, ethylene, propylene, chlorostyrene, fluorostyrene, vinylidene chloride, vinylidene fluoride, hexafluoropropylene, vinyl chloride, or chloropropene.

16. An electric apparatus, comprising the secondary battery according to claim 1.

17. The electric apparatus according to claim 16, wherein 6.49 mg/cm²≤W_{z}≤11.69 mg/cm².

18. The electric apparatus according to claim 16, wherein the first adhesive coating is provided on a side of the separator substrate facing the negative electrode sheet, and the second adhesive coating is provided on a side of the separator substrate facing the positive electrode sheet.

19. The electric apparatus according to claim 16, wherein based on the mass of the electrolyte, the mass percentage of the chain carboxylate is 18% to 40%.

20. The electric apparatus according to claim 16, wherein a thickness of the first adhesive coating is 0.2 μm to 4 μm, and a thickness of the second adhesive coating is 5 μm to 20 μm.
